(19) United States
(12) Patent Application Publication
(10) Pub. No.: US 2020/0023305 A1
(43) Pub. Date: Jan. 23, 2020

(54) DEHUMIDIFYING FILM, DEHUMIDIFYING ELEMENT, METHOD FOR FABRICATING DEHUMIDIFYING FILM, AND METHOD FOR FABRICATING DEHUMIDIFYING ELEMENT

(71) Applicant: Mitsubishi Electric Corporation, Chiyoda-ku, Tokyo (JP)

(72) Inventors: Ryota Kawashita, Tokyo (JP); Akio Masuda, Tokyo (JP)

(73) Assignee: Mitsubishi Electric Corporation, Chiyoda-ku, Tokyo (JP)

(21) Appl. No.: 16/338,072

(22) PCT Filed: Nov. 27, 2017
(86) PCT No.: PCT/JP2017/042404

§ 371 Date: Mar. 29, 2019

(30) Foreign Application Priority Data
Dec. 1, 2016 (JP) 2016-233946

(51) Int. Cl. B01D 53/26; C25B 11/03; C25B 9/04; C25B 9/10

(52) U.S. Cl. CPC B01D 53/26; C25B 9/10; C25B 9/04; C25B 11/03

(57) ABSTRACT

A dehumidifying film includes: a cathode-side electrode; a cathode-side catalyst layer; an anode-side power feeder; an anode-side catalyst layer for promoting reaction of electrolyzing water; a porous portion having a plurality of through holes formed therein, and having one part that contacts with the anode-side catalyst layer and the other part that is electrically connected to and integrated with the anode-side power feeder; and an electrolyte membrane. The anode-side power feeder, and the other part, of the porous portion, connected to the anode-side power feeder are joined by a conductive brazing material that includes a same kind of metal as a metal of the anode-side power feeder and the porous portion, and the through holes formed in the other part are filled with the conductive brazing material.

### TECHNICAL FIELD

The present invention relates to a dehumidifying film that is operated by electric power to dehumidify air on one side, a dehumidifying element that dehumidifies air in a casing in which the dehumidifying element is mounted, with the use of the dehumidifying film, a dehumidifying film production method, and a dehumidifying element production method.

### BACKGROUND ART

As a conventional art, a dehumidifying element which is, for example, disposed in a surveillance camera installed outdoors and which dehumidifies air in a casing of the surveillance camera, has been known. The dehumidifying element of the conventional art is operated by electric power, and disposed such that its anode side faces toward the inside of the casing of the surveillance camera, and its cathode side faces toward the outside of the casing. On the anode side, water in air in the casing is electrolyzed into oxygen and hydrogen ions. On the cathode side, hydrogen ions and electrons are supplied to oxygen outside the casing, to generate water (see, for example, Patent Document 1).

### CITATION LIST

### Patent Document

Patent Document 1: Japanese Laid-Open Patent Publication No. 2006-159091

### SUMMARY OF THE INVENTION

### Problems to be Solved by the Invention

The dehumidifying element of the conventional art has a problem that a part of the anode is oxidized by oxygen generated through the electrolysis of water, so that dehumidifying efficiency is reduced.

An object of the present invention is to provide a dehumidifying film, a dehumidifying element, a dehumidifying film production method, and a dehumidifying element production method that inhibit a part of an anode from being oxidized by oxygen generated through electrolysis of water, and that prevent dehumidifying effect from being reduced.

### Solution to the Problems

A dehumidifying film according to the present invention includes: a cathode-side electrode formed by a porous conductive member; a cathode-side catalyst layer that is adjacent to and electrically connected to the cathode-side electrode; an anode-side power feeder; an anode-side catalyst layer for promoting reaction of electrolyzing water; a porous portion having a plurality of through holes formed therein, the porous portion having one part that contacts with the anode-side catalyst layer and the other part that is electrically connected to and integrated with the anode-side power feeder; and an electrolyte membrane that is adjacent to and electrically connected to the cathode-side catalyst layer and the porous portion. The anode-side power feeder, and the other part, of the porous portion, connected to the anode-side power feeder are joined to each other by a conductive brazing material that includes a same kind of metal as a metal of the anode-side power feeder and the porous portion, and the through holes formed in the other part are filled with the conductive brazing material.

Furthermore, a dehumidifying element according to the present invention includes: the dehumidifying film; and a housing, formed in a tubular shape, for housing the dehumidifying film.

Furthermore, a dehumidifying element according to the present invention includes: the dehumidifying film; and an outer layer film for covering outer edge portions of the cathode-side electrode, the cathode-side catalyst layer, the porous portion, and the electrolyte membrane.

Furthermore, a dehumidifying film production method according to the present invention includes: an integrating step of forming an anode-side power feeder, and a porous portion having a plurality of through holes formed therein such that the anode-side power feeder and the porous portion are integrated with each other; a cathode-side catalyst layer applying step of applying a precursor of a cathode-side catalyst layer such that the precursor thereof is adjacent to one side of a cathode-side electrode; a stacking step of stacking an electrolyte membrane adjacent to the porous portion having been processed in the integrating step, and stacking the precursor, of the cathode-side catalyst layer, applied in the cathode-side catalyst layer applying step such that the precursor is adjacent to the electrolyte membrane; a pressing step of pressurizing and pressing the porous portion, the electrolyte membrane, the precursor of the cathode-side catalyst layer, and the cathode-side electrode which have been stacked in the stacking step, to form the precursor of the cathode-side catalyst layer into the cathode-side catalyst layer; and an anode-side catalyst layer forming step of forming an anode-side catalyst layer such that the anode-side catalyst layer is adjacent to a part of the porous portion having been processed in the pressing step. In the integrating step, the anode-side power feeder, and a connection area, of the porous portion, which is connected to the anode-side power feeder are joined to each other by a conductive brazing material that includes a same kind of metal as a metal of the anode-side power feeder and the porous portion, and the through holes formed in the connection area are filled with the conductive brazing material.

Furthermore, a dehumidifying element production method according to the present invention includes: the dehumidifying film production method; a housing step of disposing a cathode-side power feeder such that the cathode-side power feeder is adjacent to the cathode-side electrode, and housing the porous portion, the electrolyte membrane, the cathode-side catalyst layer, and the cathode-side electrode in a housing formed in a tubular shape; an inserting step of inserting, in the housing having been processed in the housing step, at least a part of a tubular portion of a flange member having a flange formed at an end portion of the tubular portion which is formed in a tubular shape; and a housing joining step of joining the housing and the flange member having been processed in the inserting step.

Furthermore, a dehumidifying element production method according to the present invention includes: the dehumidifying film production method; a film disposing step of covering outer edge portions of the cathode-side electrode, the cathode-side catalyst layer, the porous portion, and the electrolyte membrane, with a precursor of an outer layer film; and a pressuring and holding step of pressurizing and holding the cathode-side electrode, the cathode-side catalyst layer, the porous portion, the electrolyte membrane, and the precursor of the outer layer film which have been processed in the film disposing step.

### Effect of the Invention

The dehumidifying film, the dehumidifying element, the dehumidifying film production method, and the dehumidifying element production method according to the present invention can prevent oxidation of the surface portion, of the anode-side power feeder, which is connected to the porous portion, and can prevent reduction of dehumidifying effect.

### BRIEF DESCRIPTION OF THE DRAWINGS

FIG. 1 is a cross-sectional view of a configuration of a dehumidifying film according to embodiment 1 of the present invention.

FIG. 2 is an exploded perspective view of an anode-side power feeder and a porous portion according to embodiment 1 of the present invention.

FIG. 3 is a perspective view of the anode-side power feeder and the porous portion according to embodiment 1 of the present invention.

FIG. 4 illustrates the anode-side power feeder and the porous portion according to embodiment 1 of the present invention, as taken along a cross-sectional line A-A shown in FIG. 3.

FIG. 5 is a plan view of the dehumidifying element according to embodiment 1 of the present invention, as viewed from the side in the axially inward direction.

FIG. 6 is a bottom view of the dehumidifying element according to embodiment 1 of the present invention, as viewed from the side in the axially outward direction.

FIG. 7 is a cross-sectional view of the dehumidifying element according to embodiment 1 of the present invention, as taken along a cross-sectional line B-B shown in FIG. 5.

FIG. 8 is a cross-sectional view of a path, in the dehumidifying film according to embodiment 1 of the present invention, through which hydrogen ions, oxygen, and electrons transfer.

FIG. 9 is a cross-sectional view of a configuration of a dehumidifying film to be compared with the present invention.

FIG. 10 is a flow chart showing a dehumidifying film production method according to embodiment 1 of the present invention.

FIG. 11 is a flow chart showing a dehumidifying element production method according to embodiment 1 of the present invention.

FIG. 12 is a plan view of a dehumidifying element according to embodiment 2 of the present invention, as viewed from the side in the axially inward direction.

FIG. 13 is a bottom view of the dehumidifying element according to embodiment 2 of the present invention, as viewed from the side in the axially outward direction.

FIG. 14 is a cross-sectional view of the dehumidifying element according to embodiment 2 of the present invention, as taken along a cross-sectional line D-D shown in FIG. 12.

FIG. 15 is an exploded perspective view of an anode-side power feeder and a porous portion according to embodiment 2 of the present invention.

FIG. 16 is a perspective view of the anode-side power feeder and the porous portion according to embodiment 2 of the present invention.

FIG. 17 is a cross-sectional view of the anode-side power feeder and the porous portion according to embodiment 2 of the present invention, as taken along a cross-sectional line E-E shown in FIG. 16.

FIG. 18 is a flow chart showing a dehumidifying element production method according to embodiment 2 of the present invention.

FIG. 19 is a plan view of an anode-side power feeder and a porous portion according to embodiment 3 of the present invention, as viewed from the side in the axially inward direction Z1.

FIG. 20 is a perspective view of the anode-side power feeder and the porous portion according to embodiment 3 of the present invention.

FIG. 21 is a perspective view of a power feeder material that is a material of the anode-side power feeder and the porous portion according to embodiment 3 of the present invention.

FIG. 22 illustrates an opening rate and a power feeding distance according to embodiment 3 of the present invention.

FIG. 23 is a flow chart showing a dehumidifying element production method according to embodiment 3 of the present invention.

FIG. 24 is a plan view of an anode-side power feeder and a porous portion according to embodiment 4 of the present invention.

FIG. 25 is a perspective view of an anode-side power feeder and a porous portion according to embodiment 5 of the present invention.

FIG. 26 is a perspective view of a power feeder material that is a material of the anode-side power feeder and the porous portion according to embodiment 5 of the present invention.

FIG. 27 is a plan view of the anode-side power feeder and the porous portion according to embodiment 5 of the present invention.

FIG. 28 is a plan view of an anode-side power feeder and a porous portion according to embodiment 6 of the present invention.

FIG. 29 is a cross-sectional view of an anode according to embodiment 7 of the present invention, as taken along a cross-sectional plane parallel to the axial direction.

FIG. 30 is a flow chart showing a dehumidifying element production method according to embodiment 7 of the present invention.

FIG. 31 is a cross-sectional view of an anode according to embodiment 8 of the present invention, as taken along a cross-sectional plane parallel to the axial direction.

FIG. 32 is a flow chart showing a dehumidifying element production method according to embodiment 8 of the present invention.

### DESCRIPTION OF EMBODIMENTS

A plurality of embodiments for carrying out the present invention will be described below with reference to the drawings. In the following description, portions in each embodiment, which correspond to matters described in the preceding embodiments, are denoted by the same reference numerals, and repeated description may be omitted. In a case where one part of a configuration is described, the other portion of the configuration is the same as described in the preceding embodiments. Each embodiment is illustrated for embodying the technique of the present invention, and is not intended to restrict the technical scope of the present invention. The following description also includes descriptions for a dehumidifying film 1, a dehumidifying element 2, a dehumidifying film production method, and a dehumidifying element production method.

### Embodiment 1

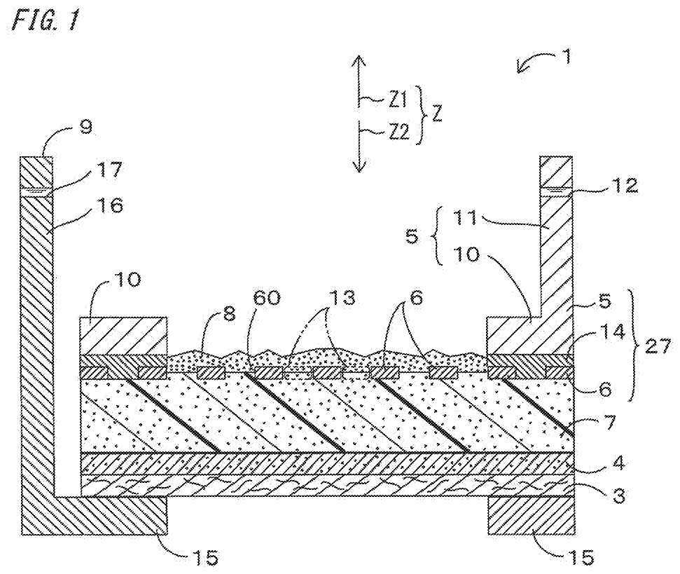

A dehumidifying film 1 and a dehumidifying element 2 according to embodiment 1 of the present invention will be described below with reference to the drawings. FIG. 1 is a cross-sectional view of a configuration of the dehumidifying film 1 according to embodiment 1 of the present invention. As shown in FIG. 1, the dehumidifying film 1 includes a cathode-side electrode 3, a cathode-side catalyst layer 4, an anode-side power feeder 5, a porous portion 6, and an electrolyte membrane 7. The cathode-side electrode 3 is formed from a porous conductive member. The cathode-side catalyst layer 4 is adjacent to and electrically connected to the cathode-side electrode 3. An anode-side catalyst layer 8 promotes the reaction of electrolyzing water. In the porous portion 6, a plurality of through holes 60 are formed, one part thereof contacts with the anode-side catalyst layer 8, and the other part thereof is electrically connected to and integrated with the anode-side power feeder 5. The electrolyte membrane 7 is adjacent to and electrically connected to the cathode-side catalyst layer 4 and the porous portion 6. A part, of the porous portion 6, which is electrically connected to the anode-side power feeder 5 is joined to the anode-side power feeder 5 by a metal.

The dehumidifying film 1 of embodiment 1 is produced as a part of the dehumidifying element 2. The dehumidifying element 2 is disposed in a casing of a security camera installed outdoors. In an optical device such as a surveillance camera which is installed outdoors, for example, the inner surface of a lens may fog up due to condensation being caused by moisture in the casing. In order to prevent this, it is desired that the inside of the casing of the surveillance camera is dehumidified, and moisture is reduced to keep air dry. The dehumidifying element 2 is connected to an external power supply, operates by power being supplied, and electrolyzes water in air in the casing of the surveillance camera, to dehumidify air in the casing.

The anode-side power feeder 5 is connected to an anode of an external power supply, and a cathode-side power feeder 9 is connected to a cathode of the external power supply. Thus, voltage is applied to the dehumidifying film 1, and the reaction indicated by formula (1) occurs on the anode side, whereby water is electrolyzed.

2H₂O→O₂+4H⁺+4e⁻ (1)

The dehumidifying element 2 is disposed such that the anode side of the dehumidifying film 1 faces toward the inside of the casing of the surveillance camera, and the cathode side thus faces toward the outside of the casing of the surveillance camera. Hereinafter, the direction toward the inside of the casing of the surveillance camera is referred to as “axially inward direction Z1”, and the direction toward the outside of the casing is referred to as “axially outward direction Z2”. Air that exits inward of the dehumidifying film 1 in the axially inward direction Z1 is air to be dehumidified. In the dehumidifying film 1, the anode-side catalyst layer 8, the porous portion 6, the electrolyte membrane 7, the cathode-side catalyst layer 4, and the cathode-side electrode 3 are stacked in order, respectively, from the side in the axially inward direction Z1, in the axially outward direction Z2. In embodiment 1, the metal with which the anode-side power feeder 5 and the porous portion 6 are joined to each other is a conductive brazing material 14. The anode-side power feeder 5 and the porous portion 6 having been integrated are referred to as “anode 27”. In embodiment 1, the anode 27 also includes the conductive brazing material 14.

A direction in which the anode-side catalyst layer 8, the porous portion 6, the electrolyte membrane 7, the cathode-side catalyst layer 4, and the cathode-side electrode 3 are stacked is referred to as “axial direction Z” which includes both the axially inward and outward directions. The dehumidifying film 1 is formed in a circular shape as viewed in the axial direction Z. An imaginary line that extends in the axial direction Z through the center of the dehumidifying film 1 is set as “axial line” of the dehumidifying film 1. Water in air that contacts with the anode-side catalyst layer 8 on the side in the axially inward direction Z1 is electrolyzed by the reaction indicated by formula (1), thereby generating oxygen. The generated oxygen is released into a space formed inward of the anode-side catalyst layer 8 in the axially inward direction Z1. Electrons generated by the reaction indicated by formula (1) are collected through the porous portion 6 into the anode-side power feeder 5, and hydrogen ions having been simultaneously generated reach the cathode-side catalyst layer 4 through the porous portion 6 and the electrolyte membrane 7.

On the cathode side, the reaction indicated by formula (2) occurs to generate water.

O₂+4H⁺+4e⁻→2H₂O (2)

On the cathode side, oxygen supplied from air on the side in the axially outward direction Z2, the hydrogen ions having reached the cathode-side catalyst layer 4, and electrons supplied from the cathode-side power feeder 9 through the cathode-side electrode 3 to the cathode-side catalyst layer 4 react as indicated by formula (2) to generate water. Thus, water in the casing of the surveillance camera appears to transfer, in the axially outward direction Z2, from the side inward of the dehumidifying film 1 in the axially inward direction Z1, and air in the casing of the surveillance camera can be dehumidified.

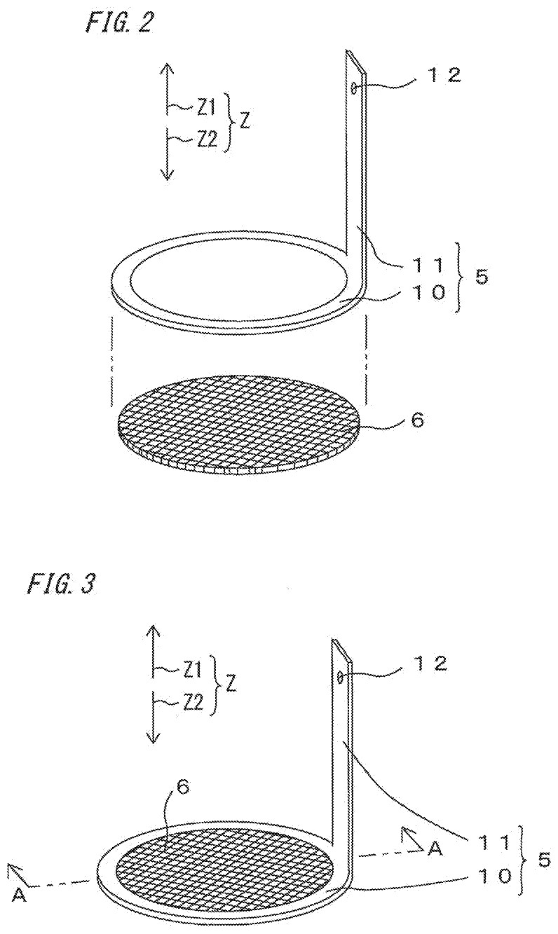

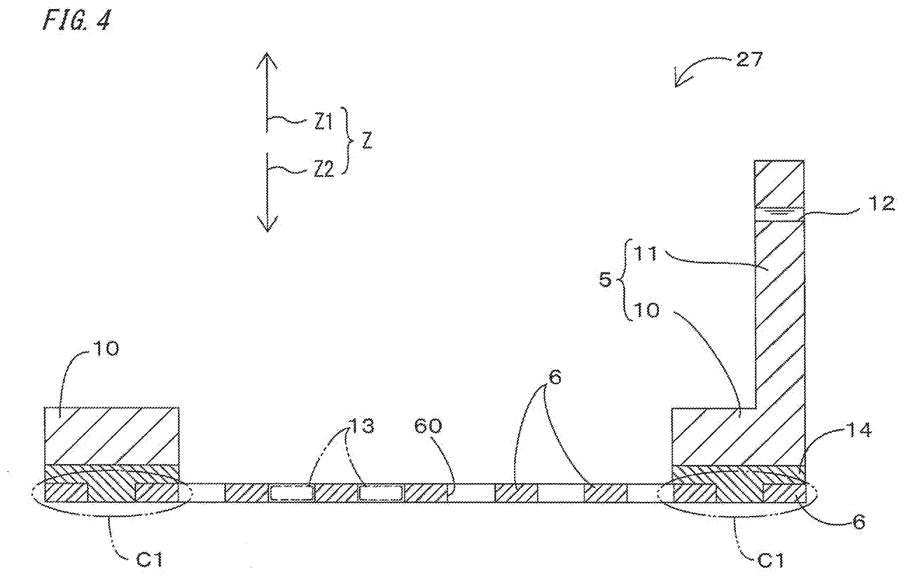

FIG. 2 is an exploded perspective view of the anode-side power feeder 5 and the porous portion 6 according to embodiment 1 of the present invention. FIG. 3 is a perspective view of the anode-side power feeder 5 and the porous portion 6 according to embodiment 1 of the present invention. FIG. 4 illustrates the anode-side power feeder 5 and the porous portion 6 according to embodiment 1 of the present invention, as taken along a cross-sectional line A-A shown in FIG. 3. The anode-side power feeder 5 includes an anode-side plate-like ring 10 and an anode-side plate-like portion 11 which are each a titanium member which has a thickness of 0.5 mm. The anode-side plate-like ring 10 is formed in a circular ring shape so as to have an inner diameter of 8 mm and an outer diameter of 8.4 mm. The anode-side plate-like ring 10 is disposed such that its thickness direction is aligned with the axial direction Z. The anode-side plate-like portion 11 extends from a part of the outer edge portion of the anode-side plate-like ring 10 in the axially inward direction Z1, and is formed in an elongated shape. The thickness direction of the anode-side plate-like portion 11 is aligned with the radial direction with respect to the axial line. An anode-side through hole 12 that penetrates in the radial direction with respect to the axial line is formed near the end portion, in the axially inward direction Z1, of the anode-side plate-like portion 11. A lead wire that forms a part of a power supply path is connected to a portion that defines the anode-side through hole 12.

The porous portion 6 is a mesh member which is made of titanium and has a thickness of 100 μm. The porous portion 6 has the plurality of through holes 60 that penetrate in the thickness direction. Spaces in the plurality of through holes 60 are referred to as “intra-hole spaces 13”. Air and water in air can transfer in the thickness direction of the porous portion 6 through the intra-hole spaces 13. The porous portion 6 is formed in a circular shape having a diameter of 8.2 mm, and is disposed outward of the anode-side plate-like ring 10 in the axially outward direction Z2 such that its thickness direction is aligned with the axial direction Z. One part of the porous portion 6 contacts with the anode-side catalyst layer 8, and the other part thereof is electrically connected to and integrated with the anode-side power feeder 5. As shown in FIG. 4, the above-described other part, of the porous portion 6, which is electrically connected to and integrated with the anode-side power feeder 5 is referred to as “connection area C1”.

The surface portion, of the anode-side plate-like ring 10, which faces the porous portion 6, and the connection area C1 of the porous portion 6 are joined to each other by the conductive brazing material 14. One part of the porous portion 6 contacts with the anode-side catalyst layer 8. The other part thereof, that is, the connection area C1 is electrically connected to and integrated with the anode-side power feeder 5. The conductive brazing material 14 contains the same kind of metal as the metal of the anode-side power feeder 5 and the porous portion 6. In order to produce the conductive brazing material 14, a titanium brazing material in a paste-like state is used as a precursor. The anode-side plate-like ring 10 and the outer edge portion of the porous portion 6 are adhered to each other by the titanium brazing material in the paste-like state, and is then baked in a vacuum state, whereby the anode-side power feeder 5 and the porous portion 6 are formed so as to be integrated with each other by the conductive brazing material 14. On the anode side, oxygen is generated as indicated by formula (1). Therefore, the porous portion 6 and the anode-side power feeder 5 are required to have high corrosion resistance. The anode-side power feeder 5, the conductive brazing material 14, and the porous portion 6 are integrated with each other, and then plated with a precious metal. The production method thereof will be described below in detail.

The porous portion 6 has the plurality of through holes 60 formed therein. In embodiment 1, the plurality of through holes 60 are formed also in the connection area C1. The plurality of through holes 60 formed in the connection area C1 are filled with the conductive brazing material 14. In other words, the intra-hole spaces 13 of the plurality of through holes 60 formed in the connection area C1 are filled with the conductive brazing material 14 which joins the anode-side power feeder 5 and the connection area C1 of the porous portion 6 to each other. When different kinds of metals coexist in a moisture-containing environment, since ionization tendency is different among the metals, corrosion of a metal having a higher ionization tendency is promoted, and bimetallic corrosion progresses. The dehumidifying film 1 is an element for electrolyzing water, and a large amount of moisture is near the anode 27. All of the anode-side power feeder 5, the porous portion 6, and the conductive brazing material 14 that contact with each other in the connection area C1 are made of the same kind of metal, and they are each a titanium member in the present embodiment. Thus, progress of the bimetallic corrosion can be prevented.

The anode-side catalyst layer 8 is formed by using a precursor in which precious metal particles and the electrolyte membrane 7 are dispersed in water or alcohol solvent, and is disposed inward of the porous portion 6 in the axially inward direction Z1. In embodiment 1, platinum particles and Nafion (registered trademark) manufactured by Du Pont are dispersed in water and the obtained product is used as a precursor of the anode-side catalyst layer 8, and applied to the porous portion 6 from the side in the axially inward direction Z1 and dried, whereby the anode-side catalyst layer 8 is formed. The anode-side catalyst layer 8 functions as a positive catalyst in the reaction indicated by formula (1). In the porous portion 6, the plurality of through holes 60 are formed so as to penetrate in the axial direction Z, and, therefore, a part of the anode-side catalyst layer 8 contacts with the electrolyte membrane 7 in the intra-hole spaces 13. The conductive brazing material 14 is disposed on the surface, of the anode-side power feeder 5, which faces the connection area C1, and, therefore, the anode-side catalyst layer 8 does not contact with the electrolyte membrane 7. Furthermore, since the intra-hole spaces 13 in the through holes 60 formed in the connection area C1 are filled with the conductive brazing material 14, if the precursor of the anode-side catalyst layer 8 is made close to the connection area C1 in the production procedure, the anode-side catalyst layer 8 is not inserted into the intra-hole spaces 13 in the connection area C1.

The surface portion, of the anode-side plate-like ring 10, which faces the porous portion 6 and the connection area C1 of the porous portion 6 are joined to each other by the conductive brazing material 14. Therefore, the members adjacent to each other in the axial direction Z not only contact with each other but also firmly bind to each other, whereby the members integrally form a conductive path. Specifically, metal atoms of the anode-side power feeder 5 and the conductive brazing material 14, respectively, bind to each other to form a conductive path, and metal atoms of the conductive brazing material 14 and the porous portion 6, respectively, also bind to each other to form a conductive path. Thus, moisture in air does not enter between the anode-side power feeder 5 and the porous portion 6 from an external space, so that oxygen atoms or oxygen molecules generated by electrolysis are prevented from contacting with the surface portion of the anode-side power feeder 5. Furthermore, when water in air is electrolyzed in the anode-side catalyst layer 8, the anode-side catalyst layer 8 does not contact with the anode-side power feeder 5, whereby oxygen atoms and oxygen molecules generated by the electrolysis are prevented from contacting with the anode-side power feeder 5.

The electrolyte membrane 7 is a solid polymer electrolyte membrane having ion conductivity for cations, and is formed by using Nafion (registered trademark) described above. When water is electrolyzed in the dehumidifying film 1, hydrogen ions permeate through the electrolyte membrane 7 from the side in the axially inward direction Z1, in the axially outward direction Z2. The electrolyte membrane 7 is disposed such that its thickness direction is aligned with the axial direction Z.

The cathode-side power feeder 9 includes a cathode-side plate-like ring 15 and a cathode-side plate-like portion 16 which are each a member which is made of stainless steel (SUS304) and has a thickness of 0.5 mm. The cathode-side plate-like ring 15 is formed in a circular ring shape having an inner diameter of 8 mm and an outer diameter of 8.4 mm, and is disposed such that its thickness direction is aligned with the axial direction Z. The cathode-side plate-like portion 16 extends from a part of the outer edge portion of the cathode-side plate-like ring 15 in the axially inward direction Z1, and is formed in an elongated shape. The thickness direction of the cathode-side plate-like portion 16 is aligned with the radial direction with respect to the axial line. A cathode-side through hole 17 that penetrates in the radial direction with respect to the axial line is formed near the end portion, in the axially inward direction Z1, of the cathode-side plate-like portion 16. A lead wire that forms a part of a power supply path is connected to a portion that defines the cathode-side through hole 17.

The cathode-side electrode 3 is a porous electrode, and is formed from carbon paper. The carbon paper is a composite material formed from carbon fibers and carbon, and is a porous member. The cathode-side electrode 3 is disposed such that its thickness direction is aligned with the axial direction Z, and is formed in a circular shape as viewed in the axial direction Z. The cathode-side catalyst layer 4 is formed inward of the cathode-side electrode 3 in the axially inward direction Z1 so as to be adjacent to the cathode-side electrode 3. The cathode-side catalyst layer 4 is made of carbon powder that carries platinum, and functions as a positive catalyst in the reaction indicated by formula (2). The production method thereof will be described below in detail.

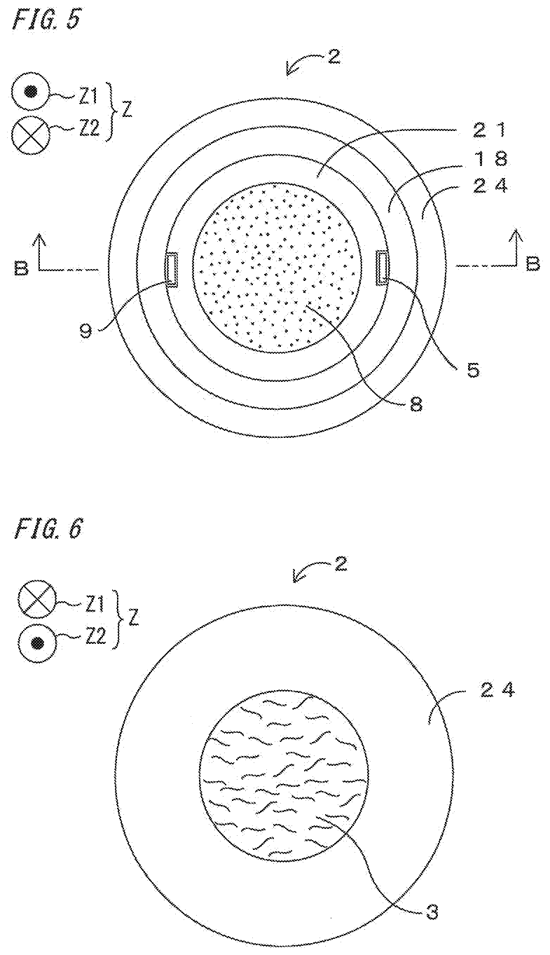

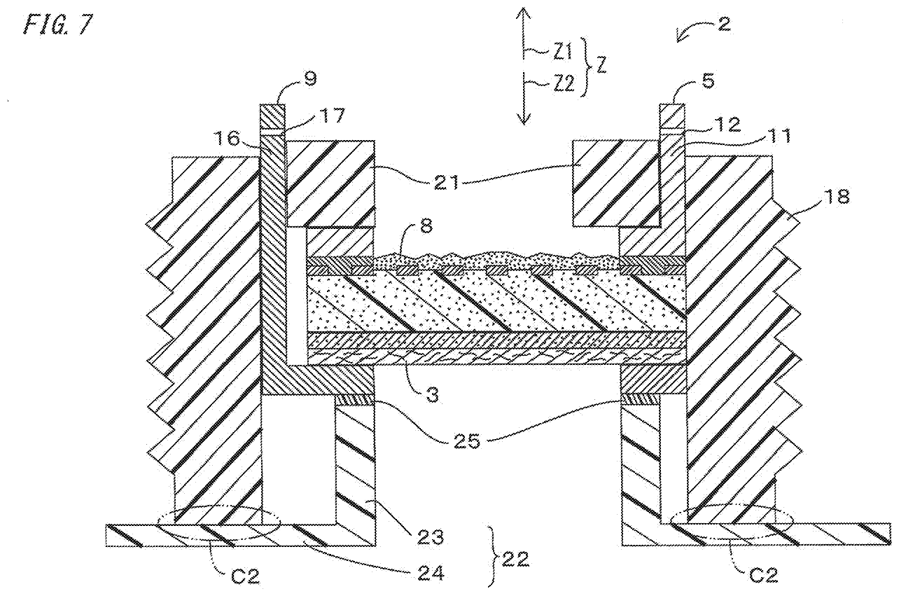

FIG. 5 is a plan view of the dehumidifying element 2 according to embodiment 1 of the present invention, as viewed from the side in the axially inward direction Z1. FIG. 6 is a bottom view of the dehumidifying element 2 according to embodiment 1 of the present invention, as viewed from the side in the axially outward direction Z2. FIG. 7 is a cross-sectional view of the dehumidifying element 2 according to embodiment 1 of the present invention, as taken along a cross-sectional line B-B shown in FIG. 5. The dehumidifying element 2 includes the dehumidifying film 1 and a housing 18. The housing 18 is formed in a tubular shape, and houses the dehumidifying film 1. In a state where the tubular housing 18 houses the dehumidifying film 1, the axial direction of the housing 18 is parallel to the axial direction Z of the dehumidifying film 1. The anode-side plate-like ring 10, the conductive brazing material 14, the porous portion 6, the anode-side catalyst layer 8, the electrolyte membrane 7, the cathode-side catalyst layer 4, the cathode-side electrode 3, and the cathode-side plate-like ring 15 in the dehumidifying film 1, are disposed in the housing 18. The portion, of the anode-side plate-like portion 11, which defines the anode-side through hole 12, and the portion, of the cathode-side plate-like portion 16, which defines the cathode-side through hole 17 are disposed so as to be exposed from the housing 18 in the axially inward direction Z1.

The housing 18 is formed from a resin. Specifically, graft copolymer obtained by graft-copolymerizing ethylene-propylene copolymer with styrene and acrylonitrile is used. This may be referred to as Techno Polymer AES (Acrylonitrile Ethylene-propylene-diene Styrene) resin. The housing 18 is formed by injection molding of this material. The housing 18 is formed from an insulating member. Therefore, even when the housing 18 contacts with both the anode-side plate-like portion 11 and the cathode-side plate-like portion 16, the housing 18 does not form a conductive path. The outer circumferential surface portion, on the radially outer side, of the housing 18 is threaded. Thus, the housing 18 functions as a male screw. When the housing 18 is rotated in the circumferential direction around the axial line, the housing 18 is screwed with a member surrounding the housing 18. A hole is formed in a casing of a surveillance camera to which the dehumidifying element 2 is mounted, and a female screw is formed in the inner circumferential surface portion that defines the hole. The housing 18 is rotated clockwise in the case of the housing 18 being viewed from the side in the axially outward direction Z2, whereby the housing 18 is moved relative to the casing of the surveillance camera in the axially inward direction Z1, and is mounted to a device by screwing.

A fitting member 21 is disposed inward of the anode-side plate-like ring 10 in the axially inward direction Z1. The fitting member 21 is formed from a resin and formed into a substantially circular ring shape. In embodiment 1, the fitting member 21 is formed by injection molding of the same material as that of the housing 18. The outer diameter of the fitting member 21 is set to be almost equal to or slightly smaller than the inner diameter of the housing 18. By the fitting member 21 being inserted into the housing 18 from the side in the axially inward direction Z1, the fitting member 21 is fitted to the radially inner side of the housing 18, so that both the fitting member 21 and the housing 18 fixedly position the dehumidifying film 1. The fitting member 21 contacts with the surface, of the anode-side plate-like ring 10, which faces in the axially inward direction Z1, at the end portion of the fitting member 21 in the axially outward direction Z2. The fitting member 21 contacts with the anode-side plate-like portion 11 and the cathode-side plate-like portion 16 from the radially inner side. The fitting member 21 is formed from an insulating member. Therefore, even when the fitting member 21 contacts with both the anode-side plate-like portion 11 and the cathode-side plate-like portion 16, the fitting member 21 does not form a conductive path.

The fitting member 21 faces the housing 18 on the outer circumferential surface in the radially outer side other than the surfaces which face the anode-side plate-like portion 11 and the cathode-side plate-like portion 16, and presses the housing 18 in the radially outward direction from the radially inner side, whereby the fitting member 21 is fitted to the housing 18. In the outer circumferential surface, on the radially outer side, of the fitting member 21, the surfaces which face the anode-side plate-like portion 11 and the cathode-side plate-like portion 16 are disposed radially inward of the outer circumferential surface other than these surfaces. By the fitting member 21 being formed in such a shape, the anode-side plate-like portion 11 and the cathode-side plate-like portion 16 are inserted in gaps formed between the fitting member 21 and the housing 18, and are disposed over the fitting member 21 from the side in the axially outward direction Z2, to the side in the axially inward direction Z1. The fitting member 21 is formed in a circular ring shape, whereby air from the side in the axially inward direction Z1 passes through a hole, on the radially inner side, of the fitting member 21, and reaches the anode-side catalyst layer 8 and the porous portion 6. In embodiment 1, the fitting member 21 is formed separately from the housing 18. However, in another embodiment of the present invention, the fitting member may be formed integrally with a tubular member similar to the housing 18, and both the fitting member and the tubular member may form a housing. In this case, the housing has, at the end portion in the axially inward direction Z1, a hole through which the anode-side plate-like portion 11 of the anode-side power feeder 5 passes, and a hole through which the cathode-side plate-like portion 16 of the cathode-side power feeder 9 passes.

A flange member 22 is disposed outward of the dehumidifying film 1 in the axially outward direction Z2. The flange member 22 includes a tubular portion 23 formed in a tubular shape, and a flange 24 formed at the end portion of the tubular portion 23. The outer diameter of the tubular portion 23 is formed so as to be smaller than the inner diameter of the housing 18, and at least a part of the tubular portion 23 is inserted into the housing 18 from the side in the axially outward direction Z2. The axial line of the tubular portion 23 coincides with the axial line of the housing 18 formed in the tubular shape. The flange 24 is formed so as to extend radially outward from the end portion, of the tubular portion 23, in the axially outward direction Z2.

The flange member 22 is formed by injection molding of the same material as that of the housing 18. In the flange member 22, the tubular portion 23 is inserted into the housing 18 in an orientation in which the flange 24 faces in the axially outward direction Z2, and, thus, the flange 24 contacts with the end surface, in the axially outward direction Z2, of the housing 18, from the side in the axially outward direction Z2. The end surface portion, in the axially outward direction Z2, of the housing 18, and the opposing surface portion, in the axially inward direction Z1, of the flange 24 are referred to as “joining area C2”. The housing 18 and the flange member 22 are joined to each other in the joining area C2, and are thus integrated with each other. In embodiment 1, the housing 18 and the flange member 22 are joined to each other by ultrasonic joining.

The end surface portion, in the axially inward direction Z1, of the flange member 22, that is, the end surface portion, in the axially inward direction Z1, of the tubular portion 23, presses the dehumidifying film 1 through a packing 25 in the axially inward direction Z1. The packing 25 is formed into a circular ring shape as viewed in the axial direction Z, and is formed from a sheet which is made of silicon resin and has an inner diameter of 8 mm and a thickness of 500 μm. The packing 25 is disposed between the tubular portion 23 and the cathode-side plate-like portion 16, to interrupt permeation of air and water. Thus, air and water on the side in the axially outward direction Z2 are prevented from passing through the dehumidifying film 1 and transferring onto the side inward of the dehumidifying element 2 in the axially inward direction Z1. Therefore, water is prevented from entering the casing of the surveillance camera installed outdoors through the dehumidifying element 2. Therefore, even in rainy weather and the like, rainwater is prevented from entering the casing of the surveillance camera through the dehumidifying element 2.

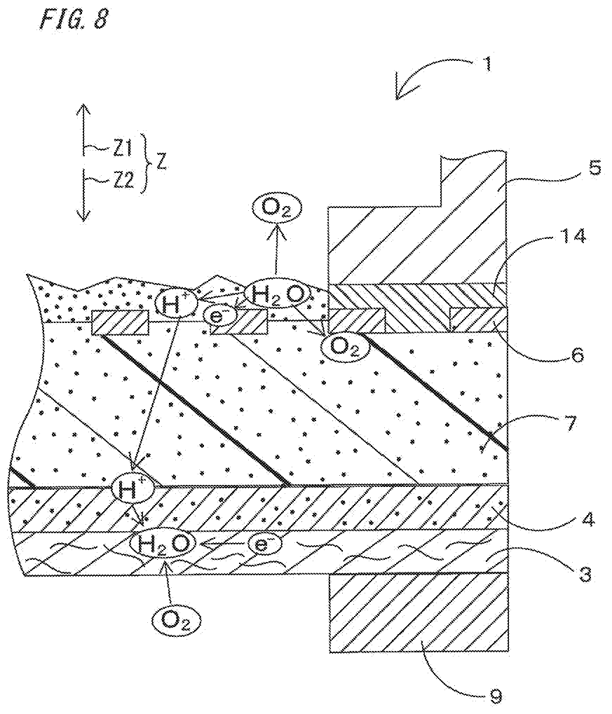

FIG. 8 is a cross-sectional view of a path, in the dehumidifying film 1 according to embodiment 1 of the present invention, through which hydrogen ions, oxygen, and electrons transfer. Water in air that has reached the anode-side catalyst layer 8 from the side inward of the dehumidifying film 1 in the axially inward direction Z1, is electrolyzed in the anode-side catalyst layer 8 in the reaction indicated by formula (1), to generate hydrogen ions, oxygen, and electrons. The hydrogen ions transfer from the anode-side catalyst layer 8 through the electrolyte membrane 7 in the axially outward direction Z2 to reach the cathode-side catalyst layer 4. Most of the oxygen generated by electrolysis is released into air on the side inward of the anode-side catalyst layer 8 in the axially inward direction Z1. However, a part of the oxygen is dispersed into the electrolyte membrane 7, and reaches a portion near the porous portion 6 and a portion near the conductive brazing material 14. The porous portion 6, the conductive brazing material 14, and the anode-side power feeder 5 form a conductive path. Therefore, oxygen in air, moisture, and oxygen generated by the electrolysis do not contact with the surface portion, of the anode-side power feeder 5, which faces the connection area C1.

The electrons generated by the electrolysis are collected through the porous portion 6 into the anode-side power feeder 5. The hydrogen ions that have transferred through the electrolyte membrane 7 in the axially outward direction Z2 react as indicated by formula (2) to generate water in the cathode-side catalyst layer 4. Specifically, the hydrogen ions react with oxygen and obtain electrons, to generate water. The oxygen is supplied to the cathode-side catalyst layer 4 from air on the side outward of the dehumidifying film 1 in the axially outward direction Z2, and the electrons are supplied to the cathode-side catalyst layer 4 from the cathode-side power feeder 9 through the cathode-side electrode 3. The water generated in the cathode-side catalyst layer 4 is released into a space on the side outward of the dehumidifying film 1 in the axially outward direction Z2.

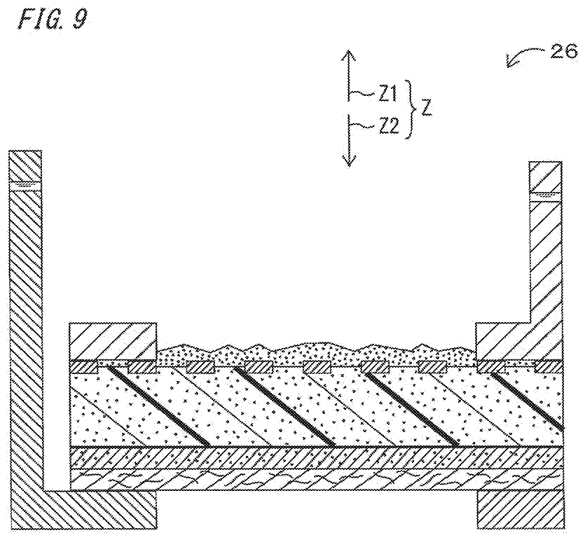

FIG. 9 is a cross-sectional view of a configuration of a dehumidifying film 26 to be compared with the present invention. In the dehumidifying film 26 to be compared, an anode-side power feeder contacts with a porous portion in a precious-metal-plated state. The anode-side power feeder and the porous portion are disposed in contact with each other in a non-integrated state. Since the anode-side power feeder and the porous portion contact with each other, conduction between the anode-side power feeder and the porous portion is enabled. A part of an anode-side catalyst layer is disposed in through holes formed in the porous portion. Therefore, at this position, the anode-side power feeder contacts with the anode-side catalyst layer. When oxygen is generated in the reaction indicated by formula (1) in the anode-side catalyst layer, the oxygen reaches the surface portion of the anode-side power feeder, and the surface portion of the anode-side power feeder is oxidized.

An accelerated life test is performed by using the dehumidifying film 26 to be compared, and a composition of the anode-side power feeder is checked. A composition of oxygen is increased in the surface portion, in the axially outward direction Z2, of the anode-side power feeder as compared to that before the accelerated life test. Furthermore, the composition of the oxygen in the surface portion of the anode-side power feeder after the accelerated life test is greater in an area which contacts with the anode-side catalyst layer than in an area which does not contact with the anode-side catalyst layer. Even when the surface portion of the anode-side power feeder is coated with a precious metal coating, the surface portion thereof is oxidized by oxygen generated in the electrolysis of water indicated by formula (1). When the surface portion of the anode-side power feeder is oxidized, resistance of the anode-side power feeder is enhanced to reduce conductivity.

According to embodiment 1 of the present invention, the dehumidifying film 1 is formed such that one part of the porous portion 6 contacts with the anode-side catalyst layer 8, and the other part of the porous portion 6 is integrated with the anode-side power feeder 5. Therefore, a conductive path is formed in a portion where the porous portion 6 and the anode-side power feeder 5 are connected. Thus, when oxygen is generated by electrolysis of water in the anode-side catalyst layer 8, the oxygen can be prevented from reaching the anode-side power feeder 5, and contact of the anode-side power feeder 5 with the oxygen can be prevented. Therefore, the surface portion, of the anode-side power feeder 5, which is connected to the porous portion 6 can be prevented from being oxidized, and electric resistance of the anode-side power feeder 5 can be inhibited from being enhanced due to change over time. Thus, as compared to a conventional art, the lifespan of the dehumidifying film 1 can be made longer, and the frequency with which the dehumidifying element 2 is changed can be reduced. Therefore, when, for example, the dehumidifying element 2 is mounted to and used in a casing of another device, the frequency with which maintenance operation for the device is performed due to deterioration of the dehumidifying film 1 can be reduced, and the interval for the maintenance operation can be made long. Thus, even when the dehumidifying element 2 is installed in another device in which a maintenance operation is complicated or a maintenance operation is difficult, reduction of long-term reliability of the other device due to the dehumidifying element 2 can be prevented.

According to embodiment 1 of the present invention, one part of the porous portion 6 contacts with the anode-side catalyst layer 8, and the other part of the porous portion 6 is joined to the anode-side power feeder 5 by a metal. Therefore, a conductive path is formed in a portion where the porous portion 6 and the anode-side power feeder 5 are connected. Thus, when oxygen is generated by electrolysis of water in the anode-side catalyst layer 8, the oxygen can be prevented from reaching the anode-side power feeder 5, and contact of the anode-side power feeder 5 with the oxygen can be inhibited. Therefore, the surface portion, of the anode-side power feeder 5, which is connected to the porous portion 6 can be prevented from being oxidized, and electric resistance of the anode-side power feeder 5 can be inhibited from being enhanced due to change over time. Thus, as compared to a conventional art, the lifespan of the dehumidifying film 1 can be made longer.

Moreover, according to embodiment 1 of the present invention, one part of the porous portion 6 contacts with the anode-side catalyst layer 8, and the other part of the porous portion 6 is joined to the anode-side power feeder 5 by the conductive brazing material 14. Thus, a conductive path is formed in a portion where the porous portion 6 and the anode-side power feeder 5 are connected. Therefore, when oxygen is generated by electrolysis of water in the anode-side catalyst layer 8, the oxygen can be prevented from reaching the anode-side power feeder 5, and contact of the anode-side power feeder 5 with the oxygen can be prevented. Furthermore, the intra-hole spaces 13 of the through holes 60 formed in the connection area C1 are filled with the conductive brazing material 14, whereby the anode-side catalyst layer 8 is not in the intra-hole spaces 13 in the connection area C1. Therefore, when oxygen is generated in the anode-side catalyst layer 8, the oxygen is also hindered from approaching the anode-side power feeder 5 through the intra-hole spaces 13 of the through holes 60 in the connection area C1. Thus, oxidation of the surface portion, of the anode-side power feeder 5, which is connected to the porous portion 6 can be reduced, and electric resistance of the anode-side power feeder 5 can be inhibited from being enhanced due to change over time. Thus, as compared to a conventional art, the lifespan of the dehumidifying film 1 can be made longer. Furthermore, the conductive brazing material 14 contains the same kind of metal as the metal of the anode-side power feeder 5 and the porous portion 6, and, therefore, even when a large amount of moisture is near the anode 27, progress of the bimetallic corrosion can be prevented.

According to embodiment 1 of the present invention, the anode-side power feeder 5, the porous portion 6, and the conductive brazing material 14 are formed from the same metal, and, specifically, are each formed from a titanium member. When an oxide film is formed on the surface of the titanium member, the titanium member is passivated. The oxide film of the titanium member does not allow oxygen to permeate therethrough, and, thus, the titanium member has high corrosion resistance. The anode 27, where a large amount of moisture is in the vicinity thereof and electrons are derived from water molecules by electric power, is in a harsh environment in which corrosion is likely to be caused, as in the dehumidifying film 1. When the anode-side power feeder 5, the porous portion 6, and the conductive brazing material 14 which form the anode 27 are formed from the same titanium member, the dehumidifying film 1 which has high corrosion resistance can be obtained. Thus, the lifespan of each of the dehumidifying film 1 and the dehumidifying element 2 can be made longer.

According to embodiment 1 of the present invention, the dehumidifying element 2 includes the dehumidifying film 1 and the housing 18, and the housing 18 is formed in a tubular shape, and houses the dehumidifying film 1. Therefore, the dehumidifying element 2 can be installed by the tubular housing 18 being inserted into a hole of a casing or the like of another device. Therefore, the dehumidifying element 2 can be prevented from occupying a large internal space of the other device, and mounting of the dehumidifying element 2 can be simplified. The dehumidifying element 2 can be installed in or mounted to any device which has a hole formed therein, whereby the dehumidifying element 2 is applicable to various devices. Therefore, the dehumidifying element 2 having high versatility can be obtained.

According to embodiment 1 of the present invention, the outer circumferential surface of the tubular housing 18 is threaded. Therefore, the dehumidifying element 2 can be screwed and inserted into a hole formed in a casing of another device to which the dehumidifying element 2 is mounted. Thus, the dehumidifying element 2 can be mounted simply and firmly to another device. Accordingly, moisture such as rainwater can be easily prevented from entering the dehumidifying element 2 and the other device from the outside. Therefore, the interval for maintenance operation can be made long. Thus, even when the dehumidifying element 2 is installed in another device in which a maintenance operation is complicated or a maintenance operation is difficult, reduction of long-term reliability of the other device due to the dehumidifying element 2 can be prevented.

According to embodiment 1 of the present invention, the flange member 22 is disposed at the end portion, in the axially outward direction Z2, of the tubular housing 18, and the flange member 22 has the flange 24 that extends radially outward. Thus, when the dehumidifying element 2 is mounted to a casing of another device by screwing using the threaded outer circumferential surface of the housing 18, the position, in the axial direction Z, of the dehumidifying element 2 can be fixed by the flange 24. Furthermore, the housing 18 and the flange member 22 are joined to each other by ultrasonic joining, whereby the housing 18 and the flange member 22 can be firmly joined to each other. Therefore, in a case where the dehumidifying element 2 is screwed into and mounted to the casing, when the housing 18 is positioned on the side in the axially inward direction Z1 to the utmost, a pressure with which the flange 24 and the casing press each other can be enhanced at a portion where the flange 24 and the casing contact with each other. Thus, air-tightness of the space, in the casing to be dehumidified, located on the side inward of the dehumidifying element 2 in the axially inward direction Z1, can be enhanced.

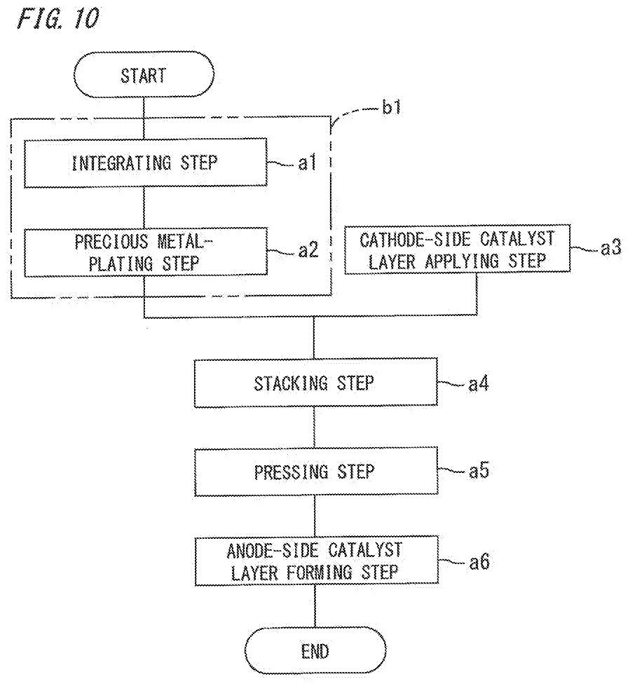

FIG. 10 is a flow chart showing the dehumidifying film production method according to embodiment 1 of the present invention. The dehumidifying film production method includes an integrating step, a cathode-side catalyst layer applying step, a stacking step, a pressing step, and an anode-side catalyst layer forming step. In the integrating step, the anode-side power feeder 5 and the porous portion 6 having the plurality of through holes 60 formed therein are integrated. In the cathode-side catalyst layer applying step, a precursor of the cathode-side catalyst layer 4 is applied so as to be adjacent to one side of the cathode-side electrode 3. In the stacking step, the electrolyte membrane 7 is disposed adjacent to the porous portion 6 having been processed in the integrating step, and the precursor of the cathode-side catalyst layer 4 having been formed in the cathode-side catalyst layer applying step is stacked so as to be adjacent to the electrolyte membrane 7. In the pressing step, the porous portion 6, the electrolyte membrane 7, the cathode-side catalyst layer 4, and the cathode-side electrode 3 which have been stacked in the stacking step are pressurized and pressed. In the pressing step of embodiment 1, a portion, of the anode-side power feeder 5, which is adjacent to and integrated with the porous portion 6 is also pressurized and pressed. In the anode-side catalyst layer forming step, the anode-side catalyst layer 8 is formed so as to be adjacent to a part of the porous portion 6.

Next, this process will be specifically described. Before the start of this process, the anode-side power feeder 5 is formed in the shape of the anode-side power feeder 5 described above. After the start of this process, the process shifts to the integrating step of step a1, the anode-side power feeder 5 and the porous portion 6 are stacked through a titanium brazing material, in a paste-like state, which is a precursor of the conductive brazing material 14, and the obtained product is put into a vacuum furnace. The vacuum furnace is heated to 880° C. at 9×10⁻⁴ Pa in a vacuum atmosphere, and this state is maintained for 10 minutes, and the vacuum furnace is then cooled. Thus, the connection area C1 of the porous portion 6 and the anode-side power feeder 5 are electrically connected and integrated. The through holes 60 are formed in the connection area C1. Therefore, the conductive brazing material 14 is disposed in the intra-hole spaces 13 of the through holes 60. In embodiment 1, the intra-hole spaces 13 formed in the connection area C1 are filled with the conductive brazing material 14. The precursor of the conductive brazing material 14 is a solid-liquid mixture containing a powdery titanium material and an organic substance. During the heating in the integrating step of step a1, the organic substance is evaporated or burned, and the titanium material is left. Thus, the conductive brazing material 14 is formed. Even if the conductive brazing material 14 formed in the integrating step of step a1 contains a small amount of organic substance, when a problem with conductivity does not arise, the conductive brazing material 14 can be used.

Next, the process shifts to the precious metal-plating step of step a2. The outer surfaces of the anode-side power feeder 5, the conductive brazing material 14, and the porous portion 6 which have been integrated are plated with platinum (symbol of element: Pt). Step a1 and step a2 correspond to a step b1 of producing the anode 27 of the dehumidifying film 1, and the integrated component formed in this step is the anode 27 of the dehumidifying film 1. In embodiment 1, the titanium brazing material is used as the conductive brazing material 14. However, in another embodiment, a conductive brazing material which has good joining properties and contains the same kind of metal as the metal of the anode-side power feeder 5 and the porous portion 6 may be used, and the conductive brazing material is not limited to the titanium brazing material. Furthermore, in embodiment 1, platinum-plating is used as the precious metal-plating. However, in another embodiment, the precious metal-plating is not limited to platinum-plating when a plating film having high corrosion resistance is formed.

Next, the process shifts to the cathode-side catalyst layer applying step of step a3, and a precursor of the cathode-side catalyst layer 4 is applied so as to be adjacent to one side of the cathode-side electrode 3. The process step of step a3 is separate from step a1 and step a2. Thus, the order in which steps a1 and a2, and the step a3 are performed may be any order. In the cathode-side catalyst layer applying step, a solid-liquid mixture that is the precursor of the cathode-side catalyst layer 4 is applied onto one surface of carbon paper by a spray-type application device. The precursor of the cathode-side catalyst layer 4 is a solid-liquid mixture in which carbon powder which carries platinum particles is mixed.

Next, the process shifts to the stacking step of step a4, and the precursor of the cathode-side catalyst layer 4 and the electrolyte membrane 7 are disposed adjacent to each other, and the anode 27, the electrolyte membrane 7, the cathode-side catalyst layer 4, and the cathode-side electrode 3 are stacked in order, respectively. In the anode 27, the porous portion 6 is disposed adjacent to the electrolyte membrane 7. Next, the process shifts to the pressing step of step a5, and the anode-side plate-like ring 10, the conductive brazing material 14, the porous portion 6, the electrolyte membrane 7, the precursor of the cathode-side catalyst layer 4, and the cathode-side electrode 3 are pressurized and pressed. The anode-side plate-like ring 10 is a portion, of the anode-side power feeder 5, which is adjacent to and integrated with the porous portion 6. Therefore, when the porous portion 6 is pressurized and pressed, the anode-side plate-like ring 10 is also pressurized and pressed. For the pressurization and pressing in the pressing step, a hot press is used and these materials are maintained at a temperature of 190° C. under a pressure of 50 kgf/cm² for five minutes. Thus, the anode-side plate-like ring 10, the conductive brazing material 14, the porous portion 6, the electrolyte membrane 7, the cathode-side catalyst layer 4, and the cathode-side electrode 3 are integrated so as to have a thickness of 400 μm to 500 μm.

After the pressing step of step a5, in the anode-side catalyst layer forming step of step a6, the anode-side catalyst layer 8 is formed. The anode-side catalyst layer 8 is formed by using, as a precursor, a solid-liquid mixture in which platinum particles and Nafion (registered trademark) described above are dispersed in water as described above. In the anode-side catalyst layer forming step, the precursor of the anode-side catalyst layer 8 is applied to the porous portion 6 from the side, of the porous portion 6, opposite to the side on which the porous portion 6 is adjacent to the electrolyte membrane 7. Since the connection area C1 of the porous portion 6 is connected to the anode-side power feeder 5, the anode-side catalyst layer 8 is applied to an area, of the porous portion 6, other than the connection area C1. The porous portion 6 has the plurality of through holes 60 that penetrate in the thickness direction. Therefore, in the area, of the porous portion 6, other than the connection area C1, a part of the precursor of the anode-side catalyst layer 8 contacts with a part of the electrolyte membrane 7 in the plurality of the intra-hole spaces 13 of the porous portion 6. Specifically, the solid-liquid mixture that is the precursor of the anode-side catalyst layer 8 is ultrasonically dispersed at the output of 40 kw for 10 minutes, and applied so as to have a thickness of 20 μm to 40 μm by using a spray-type application device. Thereafter, this is dried to volatilize moisture in the solid-liquid mixture. Thereafter, this process is ended.

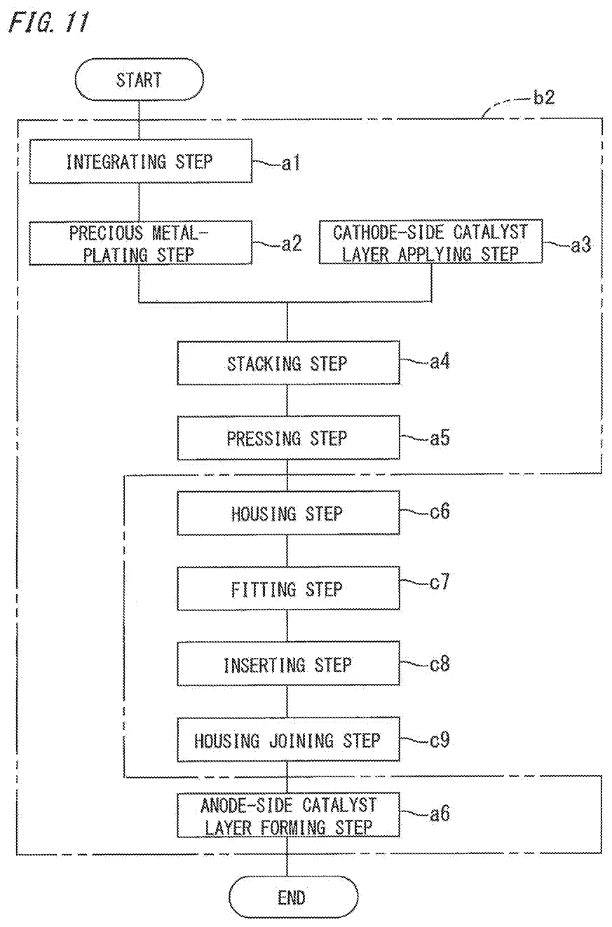

FIG. 11 is a flow chart showing the dehumidifying element production method according to embodiment 1 of the present invention. In a plurality of steps shown in FIG. 11, the steps indicated using an alternate long and two short dashes line b2 correspond to the dehumidifying film production method described above. The dehumidifying element production method includes the dehumidifying film production method, a housing step, an inserting step, and a housing joining step. In the housing step, the porous portion 6, the electrolyte membrane 7, the cathode-side catalyst layer 4, and the cathode-side electrode 3 are housed in the tubular housing 18. In the inserting step, at least a part of the tubular portion 23 of the flange member 22 in which the flange 24 is formed at the end portion of the tubular portion 23 having a tubular shape is inserted into the housing 18 having been processed in the housing step. In the housing joining step, the housing 18 and the flange member 22 having been processed in the inserting step are joined to each other.

Next, this process will be specifically described. Before the start of this process, the housing 18 is formed in the shape of the housing 18 described above. After the start of this process, as described above for the dehumidifying film production method, the process steps from the integrating step of step a1 to the pressing step of step a5 are ended, and the process subsequently shifts to the housing step of step c6. In the housing step of step c6, the cathode-side power feeder 9, and the materials having been processed in the pressing step of step a5, that is, the materials that are the porous portion 6, the anode-side plate-like ring 10 of the anode-side power feeder 5, the electrolyte membrane 7, the cathode-side catalyst layer 4, and the cathode-side electrode 3, are stacked and housed in the housing 18. At this time, all the materials, to be housed, including the cathode-side power feeder 9 are disposed with a positional relationship as described above for the dehumidifying element 2.

Next, the process shifts to the fitting step of step c7, and the fitting member 21 is fitted to the housing 18 from the side in the axially inward direction Z1. At this time, the anode-side plate-like portion 11 and the cathode-side plate-like portion 16 are inserted into gaps formed between the fitting member 21 and the housing 18 and disposed. If, in another embodiment, a fitting member and a tubular member are integrated to form a housing, the anode-side plate-like portion 11 and the cathode-side plate-like portion 16 are inserted into a plurality of holes formed in the end portion, in the axially inward direction Z1, of the housing. In this case, the fitting step of step c7 need not be performed.

Next, the process shifts to the inserting step of step c8, and the packing 25 and the flange member 22 are disposed outward of the cathode-side plate-like ring 15 in the axially outward direction Z2, and the packing 25 is pressed and held by the cathode-side plate-like ring 15 and the tubular portion 23 of the flange member 22. In this state, the flange 24 of the flange member 22 and the end surface, in the axially outward direction Z2, of the housing 18 contact with each other. Next, the process shifts to the housing joining step of step c9, and the housing 18 and the flange 24 of the flange member 22 are joined to each other. In embodiment 1, in the housing joining step, the housing 18 and the flange member 22 are joined to each other by ultrasonic joining. In the ultrasonic joining, the holding is performed for 0.2 seconds such that the output is 40 kHz and the applied pressure is 5 kgf/cm².

Next, the process shifts to the anode-side catalyst layer forming step of step a6, and the anode-side catalyst layer 8 is formed so as to be adjacent to the surface of the porous portion 6. The anode-side catalyst layer forming step of step a6 is as described above for the dehumidifying film production method. Thereafter, this process is ended.

In the dehumidifying film production method according to embodiment 1 of the present invention, the anode-side power feeder 5 and the porous portion 6 having the plurality of through holes 60 formed therein are integrated in the integrating step. Therefore, a conductive path can be formed at a portion where the porous portion 6 and the anode-side power feeder 5 are connected. Thus, when oxygen is generated by electrolysis of water in the anode-side catalyst layer 8, the oxygen can be prevented from reaching the anode-side power feeder 5, and contact of the anode-side power feeder 5 with the oxygen can be prevented. Therefore, the surface portion, of the anode-side power feeder 5, which is connected to the porous portion 6 can be prevented from being oxidized, and electric resistance of the anode-side power feeder 5 can be inhibited from being enhanced due to change over time. Thus, as compared to a conventional art, the lifespan of the dehumidifying film 1 can be made longer, and the frequency with which the dehumidifying element 2 is changed can be reduced. Therefore, when, for example, the dehumidifying element 2 is mounted to and used in a casing of another device, the frequency with which maintenance operation for the device is performed due to deterioration of the dehumidifying film 1 can be reduced, and the interval for the maintenance operation can be made long. Accordingly, even when the dehumidifying element 2 is installed in another device in which a maintenance operation is complicated or a maintenance operation is difficult, reduction of long-term reliability of the other device due to the dehumidifying element 2 can be prevented. Furthermore, the conductive brazing material 14 that connects between the anode-side power feeder 5, and the connection area C1 of the porous portion 6 contains the same kind of metal as the metal of the anode-side power feeder 5 and the porous portion 6. Therefore, the dehumidifying film 1 that can prevent progress of bimetallic corrosion even when a large amount of moisture is near the anode 27, can be produced.

Furthermore, in the dehumidifying film production method according to embodiment 1 of the present invention, the anode-side power feeder 5, the porous portion 6, and the conductive brazing material 14 are formed from the same metal, and, specifically, are each formed from a titanium member. The titanium member has high corrosion resistance. Therefore, the dehumidifying film 1 which is strong and is unlikely to corrode even when the anode 27 is in a harsh environment, can be produced. Thus, lifespan of each of the dehumidifying film 1 and the dehumidifying element 2 can be made long.

In the dehumidifying element production method according to embodiment 1 of the present invention, the porous portion 6, the electrolyte membrane 7, the cathode-side catalyst layer 4, and the cathode-side electrode 3 are housed, in the housing step, in the housing 18 formed in a tubular shape. Therefore, the dehumidifying element 2 can be installed by the tubular housing 18 being inserted into a hole of a casing or the like of another device. Therefore, the dehumidifying element 2 can be prevented from occupying a large internal space of the other device, and mounting of the dehumidifying element 2 can be simplified. The dehumidifying element 2 can be installed in or mounted to any device which has a hole formed therein, whereby the dehumidifying element 2 is applicable to various devices. Therefore, the dehumidifying element 2 having high versatility can be obtained. Furthermore, in a case where the inner circumferential portion that defines a hole in a casing to which the dehumidifying element is mounted can be threaded, when the dehumidifying element 2 is inserted into the hole, the dehumidifying element can be mounted by screwing, whereby the dehumidifying element 2 can be firmly mounted to the casing.

### Embodiment 2

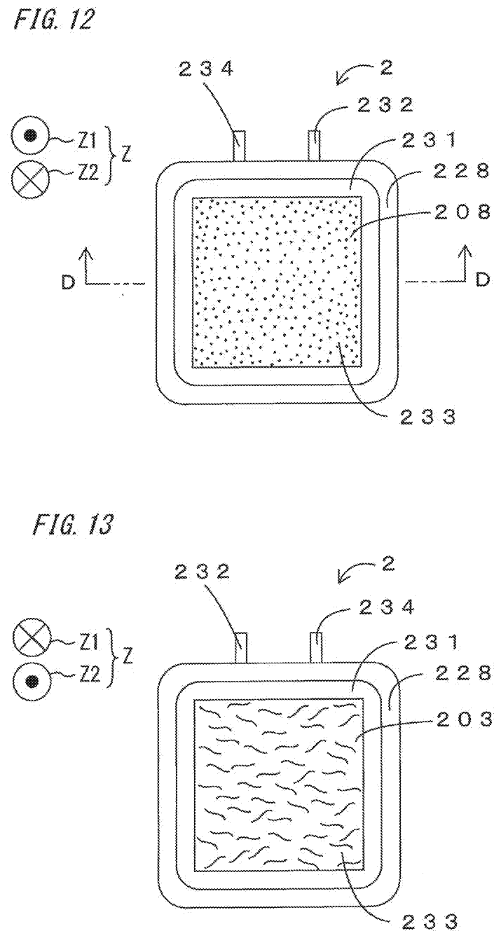

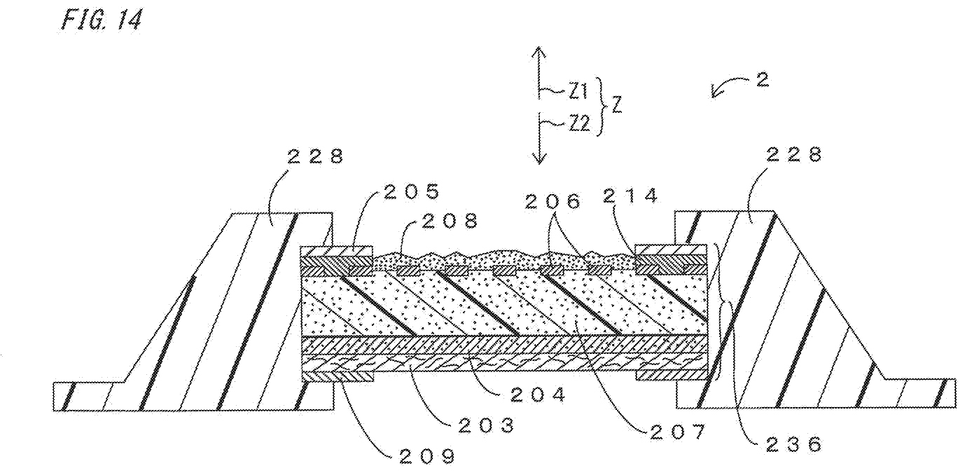

Next, a dehumidifying film 1, a dehumidifying element 2, a dehumidifying film production method, and a dehumidifying element production method according to embodiment 2 of the present invention will be described below with reference to the drawings. Embodiment 2 is similar to embodiment 1 described above. Difference of embodiment 2 from embodiment 1 will be mainly described below. FIG. 12 is a plan view of the dehumidifying element 2 according to embodiment 2 of the present invention, as viewed from the side in the axially inward direction Z1. FIG. 13 is a bottom view of the dehumidifying element 2 according to embodiment 2 of the present invention, as viewed from the side in the axially outward direction Z2. FIG. 14 is a cross-sectional view of the dehumidifying element 2 according to embodiment 2 of the present invention, as taken along a cross-sectional line D-D shown in FIG. 12.

The dehumidifying film 1 of embodiment 2 is formed in an almost quadrangular shape as viewed in the axial direction Z. The dehumidifying element 2 includes the dehumidifying film 1 and an outer layer film 228. The outer layer film 228 covers outer edge portions of a cathode-side electrode 203, a cathode-side catalyst layer 204, a porous portion 206, and an electrolyte membrane 207. An anode-side power feeder 205 includes an anode-side ring-like portion 231 and an anode-side drawn portion 232. The anode-side ring-like portion 231 and the anode-side drawn portion 232 are each a plate-like member disposed such that its thickness direction is aligned with the axial direction Z, and the anode-side ring-like portion 231 and the anode-side drawn portion 232 are combined as one member. The anode-side ring-like portion 231 is formed as a ring-like portion having a quadrangular shape as viewed in the axial direction Z. At the center portion, on the radially inner side, of the anode-side ring-like portion 231, the member is cut out in the thickness direction to form a center space region 233. An anode-side catalyst layer 208 is disposed on the porous portion 206 in the center space region 233.

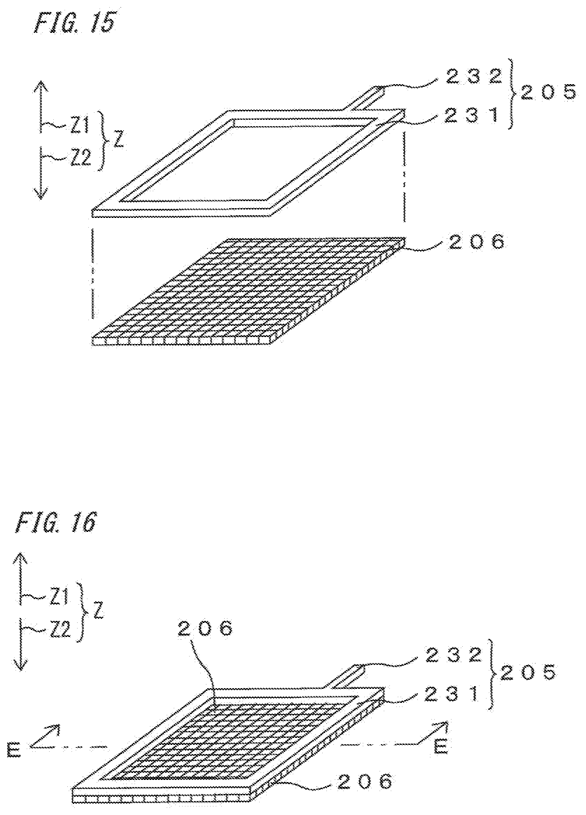

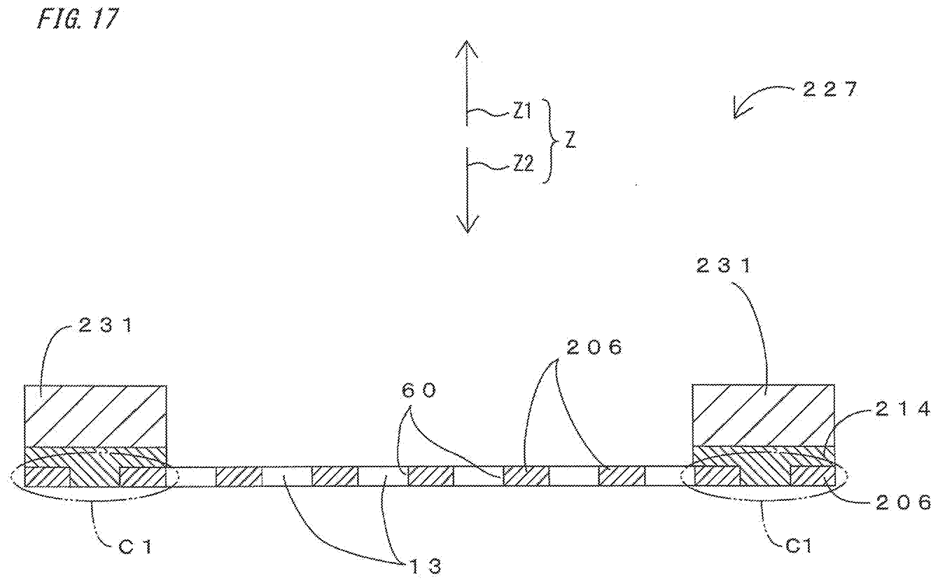

FIG. 15 is an exploded perspective view of the anode-side power feeder 205 and the porous portion 206 according to embodiment 2 of the present invention. FIG. 16 is a perspective view of the anode-side power feeder 205 and the porous portion 206 according to embodiment 2 of the present invention. FIG. 17 is a cross-sectional view of the anode-side power feeder 205 and the porous portion 206 according to embodiment 2 of the present invention, as taken along a cross-sectional line E-E shown in FIG. 16. The anode-side power feeder 205 and the porous portion 206, which have been joined to each other by a conductive brazing material 214, form an anode 227. The anode-side power feeder 205 is formed from a plate-like member which is made of titanium and has a thickness of 0.5 mm. The anode-side ring-like portion 231 is formed in a square shape having sides each of which is 90 mm long, as viewed in the thickness direction. The inner peripheral surface, on the radially inner side, of the anode-side ring-like portion 231 forms a square shape having sides each of which is 80 mm long, and defines the center space region 233.

The anode-side drawn portion 232 projects radially outward from a position, on one side forming a straight line, of the outer peripheral portion of the anode-side ring-like portion 231, so as to be elongated. Furthermore, the anode-side drawn portion 232 is continuous with the anode-side ring-like portion 231 at the position other than the center position of the side. Therefore, when the anode-side power feeder 205 is stacked over a cathode-side power feeder 209 formed in the same shape as the anode-side power feeder 205, the anode-side drawn portion 232 and a cathode-side drawn portion 234 can be displaced. A lead wire that forms a part of a power supply path is connected to the anode-side drawn portion 232.

The porous portion 206 is formed in a quadrangular shape as viewed in the axial direction Z. The porous portion 206 is a mesh member which is made of titanium and has a thickness of 100 μm, and is formed in a square shape having sides each of which is 90 mm long. The anode-side ring-like portion 231 and the porous portion 206 are disposed such that the outer peripheral portions of both of them overlap each other as viewed in the axial direction Z. The surface portion, of the anode-side ring-like portion 231, which faces the porous portion 206 and a connection area C1, of the porous portion 206, which faces the anode-side ring-like portion 231 are joined to each other by the conductive brazing material 214.

The electrolyte membrane 207 and the cathode-side electrode 203 are each formed so as to have the same shape and size as the porous portion 206 as viewed in the thickness direction. The porous portion 206, the electrolyte membrane 207, and the cathode-side electrode 203 are disposed such that the outer peripheral portions thereof overlap each other as viewed in the axial direction Z. The cathode-side catalyst layer 204 is disposed between the cathode-side electrode 203 and the electrolyte membrane 207.

The cathode-side power feeder 9 includes a cathode-side ring-like portion 235 and the cathode-side drawn portion 234. The cathode-side power feeder 9 is formed from a plate-like member made of stainless steel (SUS304), and has the same shape and size as the anode-side power feeder 205. The cathode-side ring-like portion 235 is disposed so as to contact with the cathode-side electrode 203 in a conductive manner. The anode-side ring-like portion 231, the porous portion 206, the electrolyte membrane 207, the cathode-side electrode 203, and the cathode-side ring-like portion 235 are disposed such that the outer edge portions thereof overlap each other as viewed in the axial direction Z. One side, of the anode-side ring-like portion 231, which is continuous with the anode-side drawn portion 232, and one side, of the cathode-side ring-like portion 235, which is continuous with the cathode-side drawn portion 234 are disposed so as to overlap each other as viewed in the axial direction Z, while the anode-side drawn portion 232 and the cathode-side drawn portion 234 are disposed so as to be displaced as viewed in the axial direction Z. Thus, the anode-side drawn portion 232 and the cathode-side drawn portion 234 can be prevented from contacting with each other.

Stacked portions, of the dehumidifying film 1, other than the anode-side drawn portion 232 and the cathode-side drawn portion 234 are referred to as “stacked body 236”. That is, the anode-side ring-like portion 231, the conductive brazing material 214, the porous portion 206, the electrolyte membrane 207, the cathode-side catalyst layer 204, the cathode-side electrode 203, and the cathode-side ring-like portion 235 are referred to as “stacked body 236”. The outer layer film 228 covers the outer edge portion of the stacked body 236, and at least a part of the anode-side drawn portion 232 and the cathode-side drawn portion 234 is disposed so as to project radially outward from the outer layer film 228. An opening space is formed at the center, on the radially inner side, of the outer layer film 228. Thus, the anode-side catalyst layer 208 is exposed in the axially inward direction Z1, and the cathode-side electrode 203 is exposed in the axially outward direction Z2. The opening space of the outer layer film 228 is formed in a quadrangular shape, and the quadrangular shape is a square shape having sides each of which is 82 mm long. The outer edge of the outer layer film 228 is formed in a quadrangular shape as viewed in the axial direction Z. Four sides of the outer edge of the outer layer film 228 are each set to have such a size that the outer layer film is inscribed in the square having sides each of which is 108 mm long. When the outer layer film 228 is viewed in the axial direction Z, the outer edge portions, on the radially outer side, of the outer layer film 228 at the four corners of the outer layer film 228 are each formed in an arcuate shape on the side outward of the stacked body 236 in the radially outward direction, and cover the outer edge portion of the stacked body 236 as viewed in the axial direction Z. The production method thereof will be described below in detail.

The outer edge portion of the anode-side ring-like portion 231 is covered with the outer layer film 228 as viewed in the axial direction Z, while a portion that defines the center space region 233 is exposed from the outer layer film 228 to a space on the side inward of the dehumidifying film 1 in the axially inward direction Z1. The outer edge portion of the cathode-side ring-like portion 235 is covered with the outer layer film 228 as viewed in the axial direction Z, while a portion that defines the center space region 233 is exposed from the outer layer film 228 to a space on the side outward of the dehumidifying film 1 in the axially outward direction Z2.

A hole is formed in a casing of another device to which the dehumidifying element 2 is mounted, and the dehumidifying element 2 is mounted in the hole formed in the casing of the device from the inner side of the casing so as to be adhered to a portion that defines the hole of the casing. The outer layer film 228 integrally holds the stacked body 236, and allows the dehumidifying element 2 to be mounted to a casing of another device. Thus, the outer layer film 228 fixedly positions the dehumidifying element 2 relative to the hole formed in the device. Furthermore, the outer layer film 228 prevents air and moisture from entering through the hole from the outside of the casing of the device.

According to embodiment 2 of the present invention, the outer layer film 228 integrally holds the stacked body 236, and allows the dehumidifying element 2 to be mounted to a casing of another device. Therefore, even when a member of the casing of the other device is thin, the dehumidifying element 2 can be mounted. Furthermore, the stacked body 236, the anode-side catalyst layer 208, the anode-side drawn portion 232, and the cathode-side drawn portion 234 are each formed in a thin shape that extends in the radial direction. Therefore, also when the dehumidifying element 2 is mounted in a casing of another device, a space occupied by the dehumidifying element 2 in the casing of the other device can be reduced. Thus, the dehumidifying element 2 can be inhibited from interfering with other components in the casing of the other device. Therefore, the dehumidifying element 2 having high versatility can be obtained.

According to embodiment 2 of the present invention, the outer edge portion of each of the anode-side ring-like portion 231 and the cathode-side ring-like portion 235 is covered with the outer layer film 228 as viewed in the axial direction Z, while the portions, of the anode-side ring-like portion 231 and the cathode-side ring-like portion 235, which define the center space region 233 are exposed from the outer layer film 228 to a space on the side inward of the dehumidifying film 1 in the axially inward direction Zl, and to a space on the side outward of the dehumidifying film 1 in the axially outward direction Z2, respectively. Therefore, the outer layer film 228 can be prevented from being disposed inward of the portions that define the center space region 233 in the radial direction. Thus, as compared to a case where the outer layer film 228 is disposed inward of the anode-side ring-like portion 231 and the cathode-side ring-like portion 235 in the radial direction, air on the side in the axially inward direction Z1 can contact with a wide area portion of the anode-side catalyst layer 208, and air on the side in the axially outward direction Z2 can contact with a wide area portion of the cathode-side catalyst layer 204. Accordingly, the efficiency of dehumidification by the dehumidifying element 2 can be improved.

According to embodiment 2 of the present invention, one side, of the anode-side ring-like portion 231, which is continuous with the anode-side drawn portion 232 and one side, of the cathode-side ring-like portion 235, which is continuous with the cathode-side drawn portion 234 are disposed so as to overlap each other as viewed in the axial direction Z, and the anode-side drawn portion 232 and the cathode-side drawn portion 234 are disposed so as to be displaced as viewed in the axial direction Z. Therefore, the anode-side drawn portion 232 and the cathode-side drawn portion 234 can be prevented from contacting with each other, and the anode-side drawn portion 232 and the cathode-side drawn portion 234 can be disposed so as to be close to each other. Accordingly, when a lead wire that forms a part of a power supply path for the dehumidifying element 2 is attached to each of the anode-side drawn portion 232 and the cathode-side drawn portion 234, a space occupied by the lead wire can be minimized.

The dehumidifying film production method of embodiment 2 is compared with the dehumidifying film production method of embodiment 1. Although the materials to be processed have different shapes and sizes, each step of embodiment 1 shown in FIG. 10 is similar to that of embodiment 2. The step for the anode-side plate-like ring 10 in embodiment 1 is performed for the anode-side ring-like portion 231 in embodiment 2.

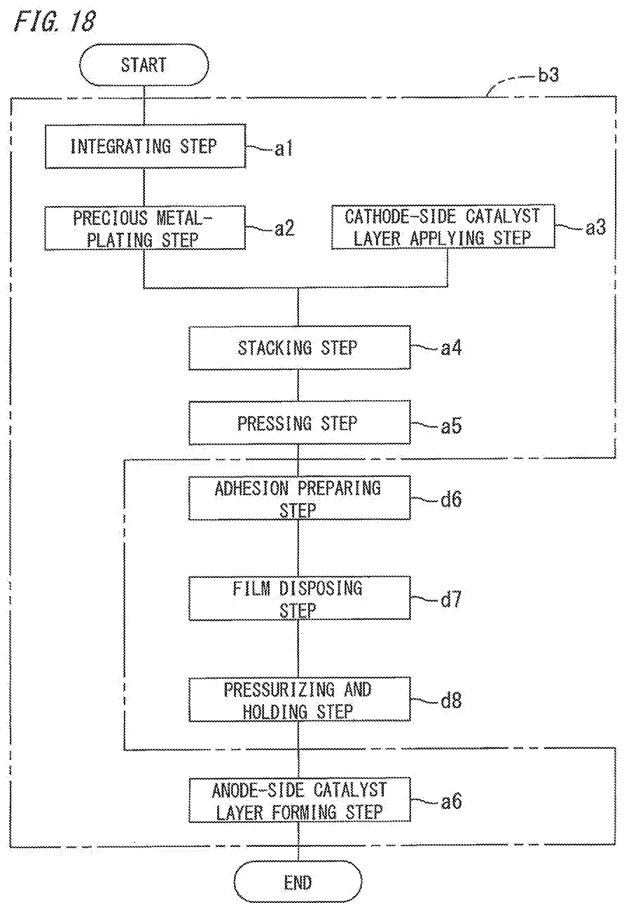

FIG. 18 is a flow chart showing the dehumidifying element production method according to embodiment 2 of the present invention. The dehumidifying element production method of embodiment 2 includes the dehumidifying film production method, a film disposing step, and a pressurizing and holding step. In the film disposing step, the outer edge portions of the cathode-side electrode 203, the cathode-side catalyst layer 204, the porous portion 206, and the electrolyte membrane 207 are covered with a precursor of the outer layer film 228. In the pressurizing and holding step, the cathode-side electrode 203, the cathode-side catalyst layer 204, the porous portion 206, the electrolyte membrane 207, and the precursor of the outer layer film 228 which have been processed in the film disposing step are pressurized and held.

In the film disposing step of embodiment 2, the outer edge portions of the anode-side ring-like portion 231 and the cathode-side ring-like portion 235 are also covered with the precursor of the outer layer film 228. In the pressurizing and holding step, the anode-side ring-like portion 231 and the cathode-side ring-like portion 235 are also pressurized and held. The anode-side ring-like portion 231 is a portion, of the anode-side power feeder 205, which is adjacent to and integrated with the porous portion 206. The cathode-side ring-like portion 235 is a portion, of the cathode-side power feeder 209, which is adjacent to and in contact with the cathode-side electrode 203.

Next, this process will be specifically described. In the plurality of steps shown in FIG. 18, the steps indicated using an alternate long and two short dashes line b3 correspond to the dehumidifying film production method. Before the start of this process, the anode-side power feeder 205, the porous portion 206, the electrolyte membrane 207, the cathode-side electrode 203, and the cathode-side power feeder 209 are formed in shapes described above. After the start of this process, the process steps from the integrating step of step a1 to the pressing step of step a5 are ended. Next, the process shifts to an adhesion preparing step of step d6. The process steps from the integrating step of step a1 to the pressing step of step a5 are similar to the process steps from the integrating step of step a1 to the pressing step of step a5 in the dehumidifying film production method described above. The step for the anode-side plate-like ring 10 in embodiment 1 is performed for the anode-side ring-like portion 231 in embodiment 2.

In the pressing step of step a5, the anode-side ring-like portion 231, the conductive brazing material 214, the porous portion 206, the electrolyte membrane 207, a precursor of the cathode-side catalyst layer 204, and the cathode-side electrode 203 are pressurized and pressed. The anode-side ring-like portion 231 is a portion, of the anode-side power feeder 205, which is adjacent to and integrated with the porous portion 206. Therefore, when the porous portion 206 is pressurized and pressed, the anode-side ring-like portion 231 is also pressurized and pressed. Thus, the anode-side ring-like portion 231, the conductive brazing material 214, the porous portion 206, the electrolyte membrane 207, the cathode-side catalyst layer 204, and the cathode-side electrode 203 are integrated.

Next, the process shifts to the adhesion preparing step of step d6. The cathode-side ring-like portion 235, and the materials having been processed in the pressing step of step a5, that is, the materials that are the porous portion 206, the anode-side ring-like portion 231, of the anode-side power feeder 205, which is integrated with the porous portion 206, the electrolyte membrane 207, the cathode-side catalyst layer 204, and the cathode-side electrode 203, are stacked to prepare for adhesion of the outer layer film 228 to the outer edge portions of these materials. That is, the stacked body 236 described above is formed by stacking in this step. The members included in the stacked body 236 are disposed with the positional relationship as described above for the dehumidifying film 1 and the dehumidifying element 2. In step d6, solution that is the precursor of epoxy resin is applied in a region, of the stacked body 236, to be adhered to the outer layer film 228.

The region to be adhered includes: the outer peripheral surface, of the surface of the stacked body 236, which faces toward the radially outward direction; the outer edge portion surface, on the radially outer side, of the anode-side ring-like portion 231, the outer edge portion surface facing toward the axially inward direction Z1; and the outer edge portion surface, on the radially outer side, of the cathode-side ring-like portion 235, the outer edge portion surface facing toward the axially outward direction Z2. As the solution for the precursor of epoxy resin, epoxy resin which is Aron Mighty (registered trademark) BX-60 manufactured by TOAGOSEI CO., LTD., is used, and this epoxy resin is applied so as to have a thickness of 20 μm. When this is in a prepreg (semi-cured) state, adhesiveness is provided.

Next, the process shifts to the film disposing step of step d7, and the precursor of the outer layer film 228 is disposed. As the precursor of the outer layer film 228, a polyethylene terephthalate film whose outer shape is a square as viewed in the thickness direction, is used, and the square has sides each of which is 108 mm long. The thickness of the precursor of the outer layer film 228 is 100 μm. The opening space having a square shape is formed at the center region as viewed in the thickness direction, and the square shape has sides each of which is 82 mm long. One precursor of the outer layer film 228 is disposed at an intended position from the side in the axially inward direction Z1, and one precursor of the outer layer film 228 is disposed at an intended position from the side in the axially outward direction Z2 such that the axial line of the opening space is aligned with the axial line of the stacked body 236. The two outer layer films 228 are disposed so as to overlap each other in the axial direction Z.

Next, the process shifts to the pressurizing and holding step of step d8, and the materials are held at a temperature of 180° C. under a pressure of 50 kgf/cm² for 15 minutes. Thus, the precursor of the outer layer film 228 is adhered to the outer edge portion of the stacked body 236, and the precursors of the two outer layer films 228 aligned in the axial direction Z are adhered to each other in a portion radially outward of the stacked body 236, to form the outer layer film 228.

Next, the process shifts to the anode-side catalyst layer forming step of step a6, and the anode-side catalyst layer 208 is disposed on the porous portion 206 from the side inward of the porous portion 206 in the axially inward direction Z1. The anode-side catalyst layer forming step of step a6 is the same as step a6 described with reference to FIG. 10. Thereafter, this process is ended.

In the dehumidifying element production method according to embodiment 2 of the present invention, the film disposing step is included in addition to the dehumidifying film production method, and, in the film disposing step, the outer layer film 228 that covers the outer edge portion of the stacked body 236 is disposed. Therefore, the dehumidifying element 2 having a thin shape can be produced. Accordingly, when the dehumidifying element 2 is mounted to another device, the dehumidifying element 2 can be prevented from occupying a large internal space of the other device, and the dehumidifying element 2 having high versatility can be obtained.

Furthermore, when the dehumidifying element 2 produced in the dehumidifying element production method according to embodiment 2 of the present invention is mounted to a casing of another device, the dehumidifying element 2 can be mounted by the dehumidifying element 2 being adhered from the inner side of the casing. Therefore, even when the member of the casing of the device is too thin for mounting the dehumidifying element 2 by the dehumidifying element 2 being inserted or screwed into the casing, the dehumidifying element 2 can be mounted. Accordingly, the dehumidifying element 2 having high versatility can be obtained.

### Embodiment 3

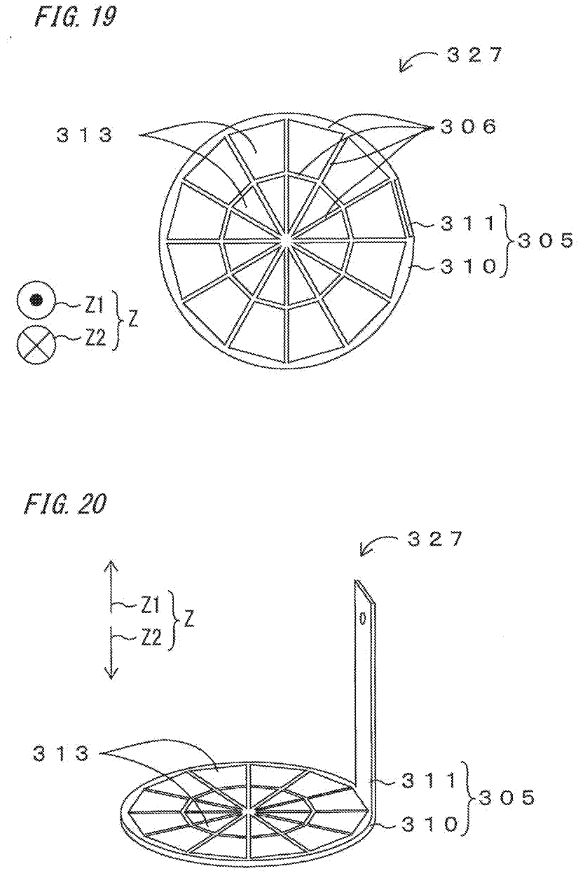

Next, a dehumidifying film 1, a dehumidifying element 2, a dehumidifying film production method, and a dehumidifying element production method according to embodiment 3 of the present invention will be described below with reference to the drawings. Embodiment 3 is similar to embodiment 1 described above. Difference of embodiment 3 from embodiment 1 will be mainly described below. FIG. 19 is a plan view of an anode-side power feeder 305 and a porous portion 306 according to embodiment 3 of the present invention, as viewed from the side in the axially inward direction Z1. FIG. 20 is a perspective view of the anode-side power feeder 305 and the porous portion 306 according to embodiment 3 of the present invention. FIG. 21 is a perspective view of a power feeder material 337 that is a material of the anode-side power feeder 305 and the porous portion 306 according to embodiment 3 of the present invention.

In embodiment 3, the anode-side power feeder 305 and the porous portion 306 are formed as one member, to form an anode 327. The anode-side power feeder 305 includes an anode-side plate-like portion 311 and an anode-side plate-like ring 310. The porous portion 306 is formed, in a portion radially inward of the anode-side plate-like ring 310, from the same member as the anode-side plate-like ring 310 so as to be continuous therewith. The porous portion 306 defines intra-hole spaces 313. In embodiment 1, the through holes 60 of the porous portion 6 are formed over the entirety of the porous portion 6, and are formed also in the connection area C1. Meanwhile, in embodiment 3, the outer circumferential portion of the porous portion 306 is connected to the anode-side power feeder 305, and no through holes that face the anode-side power feeder 305 are formed in the outer circumferential portion of the porous portion 306.

The power feeder material 337 is a plate-like material, and includes a circular portion, and an elongated plate-like portion that extends from a part of the outer edge of the circular portion so as to be perpendicular to the circular portion. The circular portion and the elongated plate-like portion are formed as one member. The outer edge portion, on the radially outer side, of the circular portion, and the elongated plate-like portion that extends from a part of the outer edge portion in the thickness direction form the anode-side power feeder 305, and form a part of a power supply path for the porous portion 306. The circular portion is a plate which is made of titanium and has a diameter of 8.4 mm and a thickness of 0.5 mm, and the circular portion of the metal plate made of titanium is punched by laser processing, thereby forming intra-hole spaces 13 that penetrate in the thickness direction. A portion that defines the intra-hole spaces 13 is the porous portion 306. In embodiment 1, the porous portion 6 is disposed outward of the anode-side plate-like ring 10 of the anode-side power feeder 5 in the axially outward direction Z2. However, in embodiment 3, the porous portion 306 is disposed radially inward of the anode-side plate-like ring 310 formed in the circular plate-like shape.

The porous portion 306 is formed as a portion that is left after the circular portion of the power feeder material 337 has been cut out by punching process. In the punching process, one diameter of the outer circumferential circle of the circular portion, a diameter that intersects the one diameter at 30 degrees, a diameter that intersects the one diameter at 60 degrees, and a diameter that intersects the one diameter at 90 degrees are set in the circular portion of the power feeder material 337. The circular portion is punched such that elongated portions along the plurality of diameters are left unpunched. Furthermore, in the punching process, a polygon that is smaller than the outer circumferential circle and that has the same center as the outer circumferential circle, is set in the circular portion of the power feeder material 337, and the circular portion is punched such that an elongated portion along the polygon is left unpunched. Thus, the intra-hole spaces 13 that form 12 triangles are formed on the side radially inward of the polygon having been set, and the intra-hole spaces 13 that form 12 trapezoids are formed on the side radially outward of the polygon having been set.

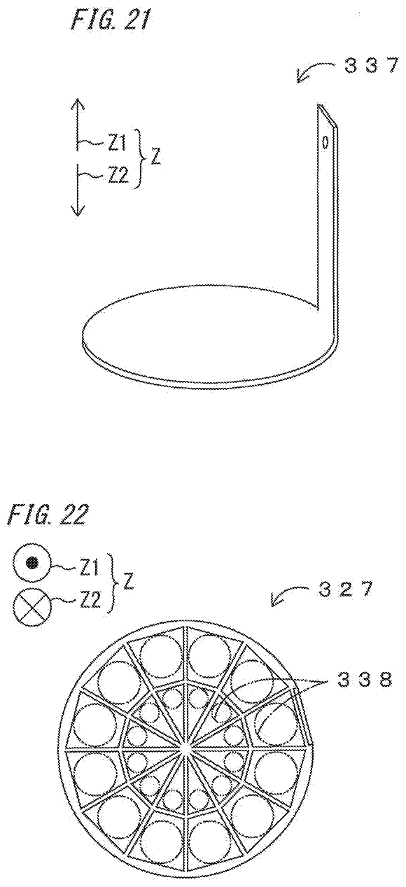

FIG. 22 illustrates an opening rate and a power feeding distance according to embodiment 3 of the present invention. When the anode-side plate-like ring 310, of the anode-side power feeder 305, formed in a circular plate-like shape, and the porous portion 306 are orthogonally projected onto the plane perpendicular to the axial direction Z, an area occupied by the intra-hole spaces 313 relative to an area of the circle formed by the outer edge of the anode-side power feeder 305 is referred to as “opening rate”. In embodiment 3, the opening rate is set to 65%. The radius of the largest inscribed circle 338 that is inscribed in the intra-hole space 313 in the case of the porous portion 306 being viewed in the axial direction Z, is referred to as “power feeding distance” for the intra-hole space 313. In embodiment 3, the maximum power feeding distance is set to 0.7 mm. The shorter the power feeding distance is, the more easily electrons generated in the reaction indicated by formula (1) reach the anode-side power feeder 305. The greater the opening rate is, the more easily hydrogen ions generated in the reaction indicated by formula (1) in an anode-side catalyst layer 308 transfer through an electrolyte membrane 307 in the axial direction Z.

According to embodiment 3 of the present invention, the anode-side power feeder 305 and the porous portion 306 are formed as one member. Therefore, when oxygen is generated by electrolysis of water in the anode-side catalyst layer 308, the oxygen can be prevented from reaching the anode-side power feeder 305, and contact of the anode-side power feeder 305 with the oxygen can be prevented. Therefore, oxidation of the surface portion, of the anode-side power feeder 305, which is connected to the porous portion 306 can be prevented, and electric resistance of the anode-side power feeder 305 can be inhibited from being enhanced due to change over time. Thus, as compared to a conventional art, lifespan of the dehumidifying film 1 can be made longer, and the frequency with which the dehumidifying element 2 is changed can be reduced. Therefore, when, for example, the dehumidifying element 2 is mounted to and used in a casing of another device, the frequency with which maintenance operation for the device is performed due to deterioration of the dehumidifying film 1 can be reduced, and the interval for the maintenance operation can be made long. Accordingly, even when the dehumidifying element 2 is installed in another device in which a maintenance operation is complicated or a maintenance operation is difficult, reduction of long-term reliability of the other device due to the dehumidifying element 2 can be prevented.

Furthermore, according to embodiment 3 of the present invention, the opening rate is set to 65% and the average power feeding distance is set to 0.7 mm in the porous portion 306 and the circular-plate-like portion of the anode-side power feeder 305. Thus, the dehumidifying film 1 that allows electrons generated by the reaction of electrolyzing water to easily reach the anode-side power feeder 305, and that allows hydrogen ions generated by the reaction of electrolyzing water to easily transfer through the electrolyte membrane 307 in the axial direction Z can be obtained. Accordingly, the dehumidifying element 2 that efficiently exhibits dehumidifying effect can be obtained.

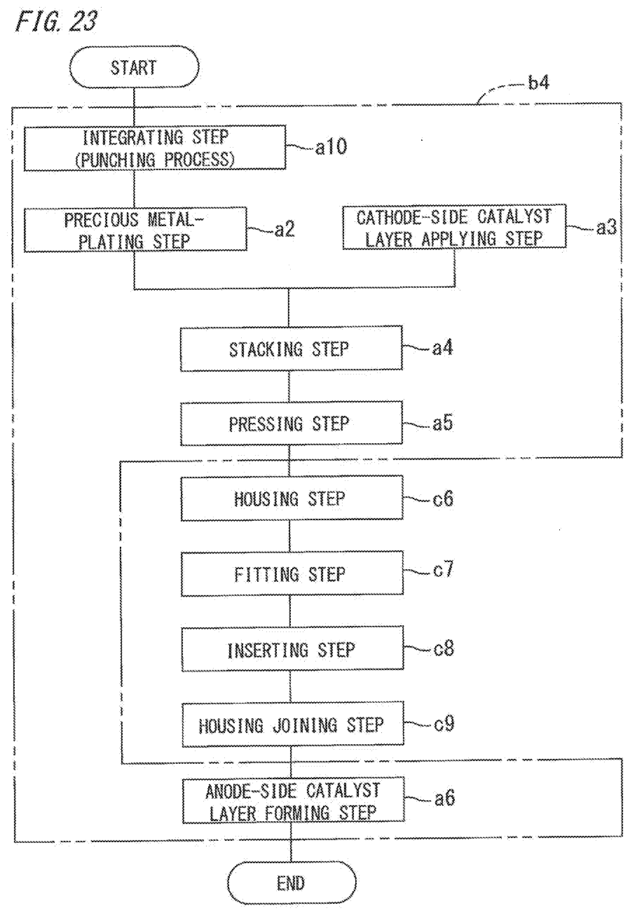

FIG. 23 is a flow chart showing the dehumidifying element production method according to embodiment 3 of the present invention. After the start of this process, the process shifts to an integrating step of step a10, and the anode-side power feeder 305 and the porous portion 306 are formed as an integrated portion. A plate-like member which is made of titanium and has a thickness of 0.5 mm is punched by layer processing, and processed so as to have the above-described shape and size. Next, the process shifts to a precious metal-plating step of step a2, and platinum-plating is performed. This step is the same as step a2 in embodiment 1 shown in FIG. 11. Thus, a precious metal film having corrosion resistance is formed on the surfaces of the anode-side power feeder 305 and the porous portion 306. In embodiment 3, platinum-plating is performed. However, in the present invention, the precision metal-plating is not limited to platinum-plating. In another embodiment of the present invention, a plating material having excellent corrosion resistance can be used.

The positional relationship between the anode-side plate-like ring 10 of embodiment 1 and the porous portion 6 (porous portion 306) is different from the positional relationship between the anode-side plate-like ring 310 formed in a circular plate shape according to embodiment 3, and the porous portion 6 (porous portion 306). However, in the dehumidifying element production method, the process steps from step a3 to step a5, the process steps from step c6 to step c9, and the process step of step a6 are the same as those of embodiment 1. After the anode-side catalyst layer forming step has been ended, this process is ended. In the plurality of steps shown in FIG. 23, the steps indicated using an alternate long and two short dashes line b4 correspond to the dehumidifying film production method.

In the dehumidifying film production method and the dehumidifying element production method according to embodiment 3 of the present invention, the anode-side power feeder 305 and the porous portion 306 are formed as one member in the integrating step. Therefore, when oxygen is generated by electrolysis of water in the anode-side catalyst layer 308, the oxygen can be prevented from reaching the anode-side power feeder 305, and contact of the anode-side power feeder 305 with the oxygen can be prevented. Accordingly, as compared to a conventional art, lifespan of the dehumidifying element 2 can be made longer. Furthermore, as compared to a case where the anode-side power feeder 305 and the porous portion 306 are formed as separate members, and are joined to each other, the operation for the integrating step can be simplified. Accordingly, the dehumidifying element 2 having high reliability can be easily produced.

### Embodiment 4

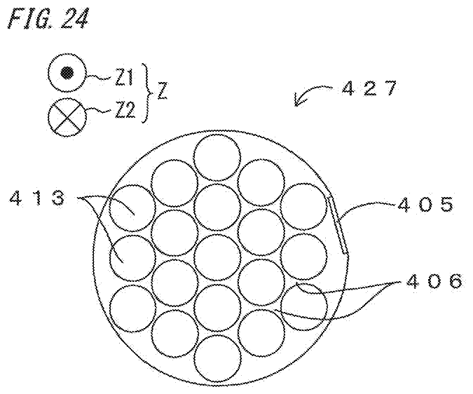

Embodiment 4 is similar to embodiment 3 described above. Difference of embodiment 4 from embodiment 3 will be mainly described below. FIG. 24 is a plan view of an anode-side power feeder 405 and a porous portion 406 according to embodiment 4 of the present invention. An anode 427 includes the anode-side power feeder and the porous portion 406. In embodiment 4, a plurality of intra-hole spaces 413 are formed, in a circular-plate-like portion of the anode-side power feeder 405, so as to penetrate in the thickness direction. Each intra-hole space 413 is formed in a circular shape as viewed in the thickness direction. A portion that defines the intra-hole spaces 413 is the porous portion 406. The size of the circle of the intra-hole space 413 is the same among all of the intra-hole spaces 413, and the intra-hole spaces 413 adjacent to each other are formed so as to be close to each other. Therefore, a portion that separates the adjacent intra-hole spaces 413 from each other is formed in an elongated shape.

Thus, a dehumidifying film 1 that allows the opening rate to be increased, and allows hydrogen ions generated by electrolysis of water to efficiently transfer in the axial direction Z, can be obtained. Furthermore, since the anode-side power feeder 405 and the porous portion 406 are formed as one member, when oxygen is generated by electrolysis of water in an anode-side catalyst layer 408, the oxygen can be prevented from reaching the anode-side power feeder 405, and contact of the anode-side power feeder 405 with the oxygen can be prevented. Therefore, oxidation of the surface portion, of the anode-side power feeder 405, which is connected to the porous portion 406 can be prevented. As compared to a conventional art, lifespan of each of the dehumidifying film 1 and a dehumidifying element 2 can be made longer.

### Embodiment 5

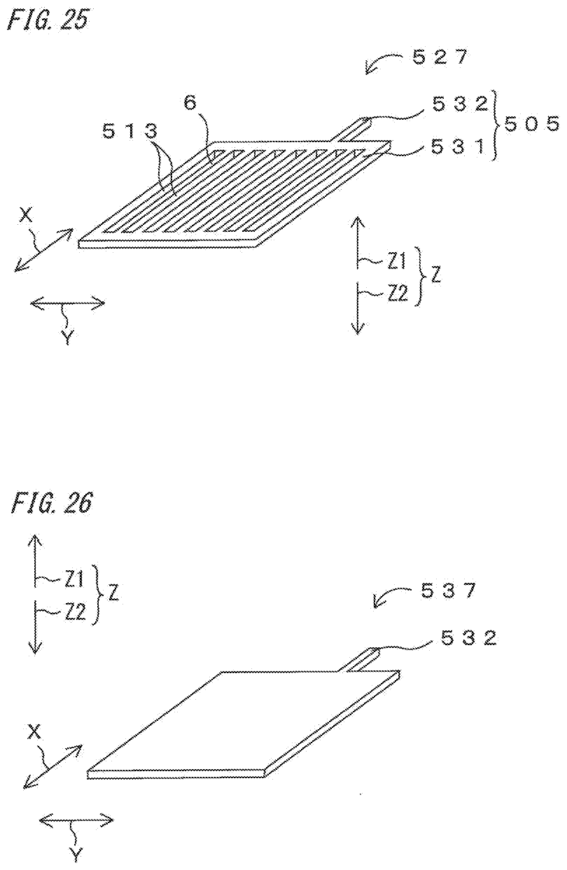

Next, a dehumidifying film 1, a dehumidifying element 2, a dehumidifying film production method, and a dehumidifying element production method according to embodiment 5 of the present invention will be described below with reference to the drawings. Embodiment 5 is similar to embodiment 2 described above. Difference of embodiment 5 from embodiment 2 will be mainly described below. FIG. 25 is a perspective view of an anode-side power feeder 505 and a porous portion 506 according to embodiment 5 of the present invention. FIG. 26 is a perspective view of a power feeder material 537 that is a material of the anode-side power feeder 505 and the porous portion 506 according to embodiment 5 of the present invention.

In embodiment 5, the anode-side power feeder 505 and the porous portion 506 are formed as one member, to form an anode 527. The anode-side power feeder 505 includes an anode-side drawn portion 532 and an anode-side ring-like portion 531. The porous portion 506 is formed, in a portion radially inward of the anode-side ring-like portion 531, from the same member as the anode-side ring-like portion 531 so as to be continuous therewith. The porous portion 506 defines intra-hole spaces 513.

The power feeder material 537 includes a quadrangular-plate-like portion, and the anode-side drawn portion 532 formed in an elongated-plate-like shape so as to project radially outward from a part of the outer edge of the quadrangular-plate-like portion. The quadrangular-plate-like portion and the anode-side drawn portion 532 are formed as one member. The outer edge portion of the quadrangular-plate-like portion is formed in a quadrangular shape, and the anode-side drawn portion 532 projects from a position on one side of the quadrangular-plate-like portion. The direction that is perpendicular to one side, of the outer edge portion of the quadrangular-plate-like portion, which is continuous with the anode-side drawn portion 532, and that is perpendicular to the thickness direction of the quadrangular-plate-like portion is referred to as “first direction X”. The direction which is perpendicular to the first direction X in the outer edge portion of the quadrangular-plate-like portion and is perpendicular to the thickness direction of the quadrangular-plate-like portion is referred to as “second direction Y”.

The outer edge portion, on the radially outer side, of the quadrangular-plate-like portion, and the elongated plate-like portion formed so as to project radially outward from a part of the outer edge portion, correspond to the anode-side power feeder 505, and form a part of a power supply path for the porous portion 506. The quadrangular-plate-like portion is a plate which is made of titanium, has a square shape having sides each of which is 90 mm long, and has a thickness of 0.5 mm. The intra-hole spaces 513 that penetrate in the thickness direction are formed by a circular portion of a metal plate made of titanium being punched by laser processing. A portion that defines the intra-hole spaces 513 is the porous portion 506. In embodiment 2, the porous portion 206 is disposed on the side outward of the anode-side ring-like portion 231 in the axially outward direction Z2. However, in embodiment 5, the porous portion 506 is disposed radially inward of the quadrangular-plate-like portion of the anode-side power feeder 505.

The porous portion 506 is formed as a portion which is left after the quadrangular portion of the power feeder material 537 has been cut by punching process. In the punching process, a plurality of elongated area portions parallel to the first direction X are cut out from the quadrangular portion of the power feeder material 537, thereby forming the intra-hole spaces 513. The plurality of elongated area portions, which are cut out, are elongated in the first direction X. The length thereof in the first direction X is slightly shorter than the length of one side of the quadrangular portion of the power feeder material 537, and the elongated area portions are aligned in the second direction Y. The porous portion 506, which is left after the cut-out, is formed so as to include a plurality of elongated portions which extend in the first direction X, and are aligned in the second direction Y.

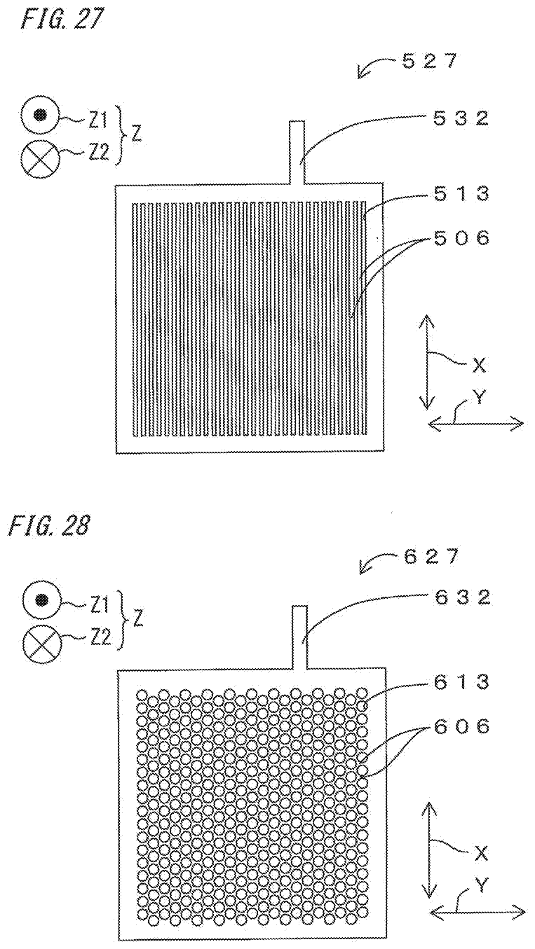

FIG. 27 is a plan view of the anode-side power feeder 505 and the porous portion 506 according to embodiment 5 of the present invention. Specifically, in embodiment 5, as shown in FIG. 27, the plurality of the intra-hole spaces 513 are formed so as to be aligned in the second direction Y. As described above, the shorter the power feeding distance is, the more preferable the effect is. The greater the opening rate is, the more preferable the effect is. In embodiment 5, the power feeding distance is set to 1 mm, and the opening rate is set to 62%. Thus, electrolysis of water can be efficiently performed, and hydrogen ions can be transferred with enhanced efficiency, and the dehumidifying film 1 and the dehumidifying element 2 having high efficiency can be obtained.

The porous portion 506 includes the plurality of elongated portions that extend in the first direction X, and the intra-hole spaces 513 that are defined by the plurality of elongated portions are also formed so as to be elongated in the first direction X. Therefore, as compared to a case where the intra-hole spaces 513 are each formed in another shape, the number of the intra-hole spaces 513 can be reduced, in other words, the number of times of punching by laser processing can be reduced, the power feeding distance can be shortened, and the opening rate can be increased.

Accordingly, the dehumidifying film 1 and the dehumidifying element 2 having high dehumidifying efficiency can be obtained.

In the dehumidifying film production method and the dehumidifying element production method according to embodiment 5, the anode-side power feeder 505 and the porous portion 506 are formed as an integrated portion in the integrating step. A plate-like member which is made of titanium and has a thickness of 0.5 mm is punched by laser processing, and processed so as to have the above-described shape and size. The process steps from the subsequent precious metal-plating step to the anode-side catalyst layer forming step are the same as described for embodiment 2. However, the process for the anode-side ring-like portion 531 in embodiment 2 is performed for the quadrangular-plate-like portion of the anode-side power feeder 505 in embodiment 5.

In the dehumidifying film production method and the dehumidifying element production method according to embodiment 5 of the present invention, the anode-side power feeder 505 and the porous portion 506 are formed as one member in the integrating step. Accordingly, when oxygen is generated by electrolysis of water in an anode-side catalyst layer 508, the oxygen can be prevented from reaching the anode-side power feeder 505, and contact of the anode-side power feeder 505 with the oxygen can be prevented. Therefore, as compared to a conventional art, lifespan of the dehumidifying element 2 can be made longer. Furthermore, as compared to a case where the anode-side power feeder 505 and the porous portion 506 are formed as separate members and are joined to each other, the operation for the integrating step can be simplified. Accordingly, the dehumidifying element 2 having high reliability can be easily produced.

### Embodiment 6

Embodiment 6 is similar to embodiment 5 described above. Difference of embodiment 6 from embodiment 5 will be mainly described below. FIG. 28 is a plan view of an anode-side power feeder 605 and a porous portion 606 according to embodiment 6 of the present invention. An anode 627 includes the anode-side power feeder 605 and the porous portion 606. Similarly to embodiment 5, the direction that is perpendicular to one side, of the outer edge portion of a quadrangular-plate-like portion, which is continuous with an anode-side drawn portion 632, and that is perpendicular to the thickness direction of the quadrangular-plate-like portion is referred to as “first direction X”. The direction which is perpendicular to the first direction X in the outer edge portion of the quadrangular-plate-like portion and is perpendicular to the thickness direction of the quadrangular-plate-like portion is referred to as “second direction Y”.

The porous portion 606 is formed as a portion which is left after the quadrangular portion has been cut by the punching process. In the punching process, a plurality of circular area portions are cut out from the quadrangular portion of a power feeder material 637 as viewed in the thickness direction, to form a plurality of circular intra-hole spaces 613. The diameters of the plurality of circular shapes are set to be the same. Three or more intra-hole spaces 613 are formed so as to be close to each other in the first direction X and form a line. The centers of the circles of the intra-hole spaces 613 adjacent to each other in the first direction X are set to be spaced from each other over a predetermined distance. The predetermined distance is referred to as “distance between centers”.

The intra-hole spaces 613 are aligned in the first direction X so as to form a line, and a plurality of the lines formed by the intra-hole spaces 613 are aligned in the second direction Y. The intra-hole spaces 613 adjacent to each other in the second direction Y are closest to each other in two directions which are perpendicular to the thickness direction and intersect the first direction X at 60 degrees. The centers of the circles of the intra-hole spaces 613 disposed adjacent to each other are set to be spaced at regular intervals in the two directions each forming 60 degrees relative to the first direction X, and this interval is set to be equal to the distance between centers described above. The distance between the centers of the intra-hole spaces 613 closely disposed adjacent to each other, is set so as to be slightly longer than the diameter of the circle of the intra-hole space 613. Thus, the porous portion 606, formed as a portion which is left after the circular area portions have been cut out, form a structure similar to a honeycomb structure as viewed in the thickness direction. The porous portion 606 having been thus formed is disposed in a dehumidifying film 1 and a dehumidifying element 2 such that its thickness direction is aligned with the axial direction Z.

The smaller the diameter of the circle of the intra-hole space 613 is and the greater the number of the intra-hole spaces 613 is, the shorter the power feeding distance can be and the greater the opening rate can be. Thus, both efficiency of electrolysis of water and efficiency of transferring hydrogen ions can be enhanced. Accordingly, the dehumidifying film 1 and the dehumidifying element 2 having high efficiency can be obtained.

### Embodiment 7

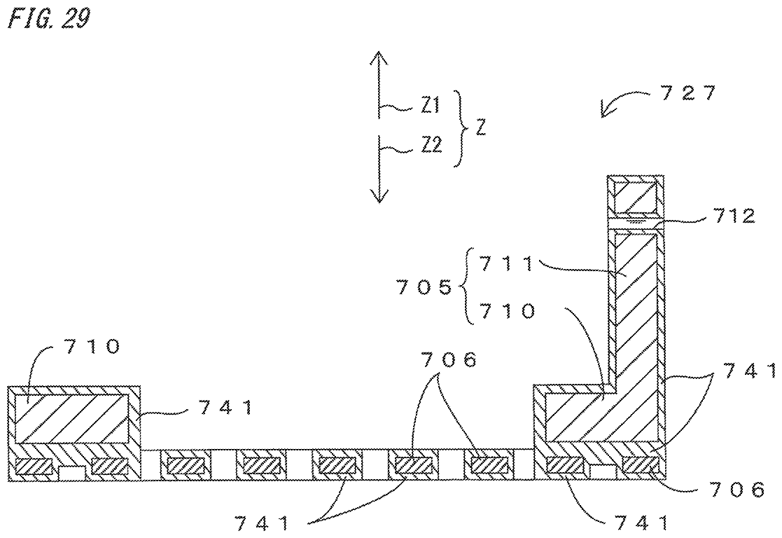

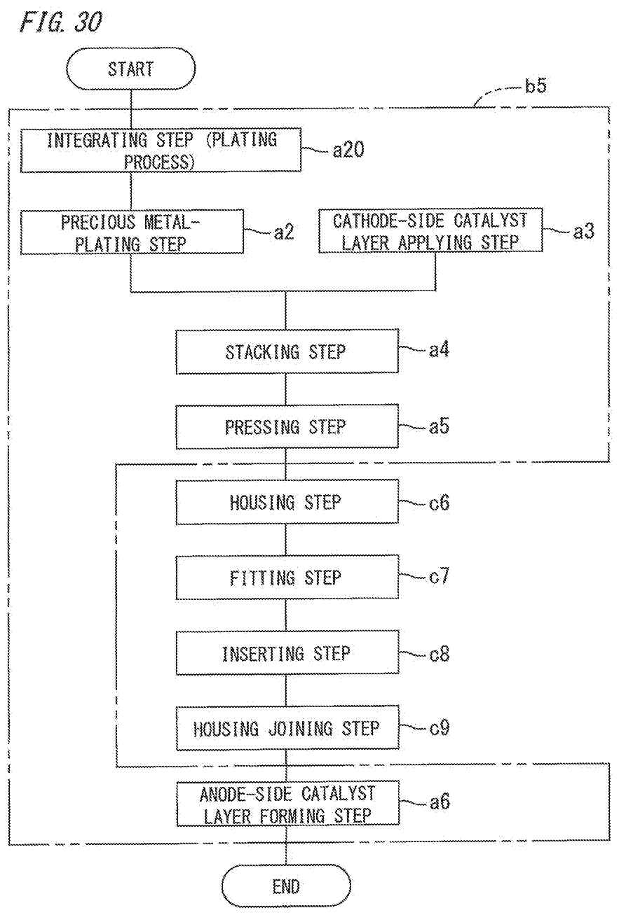

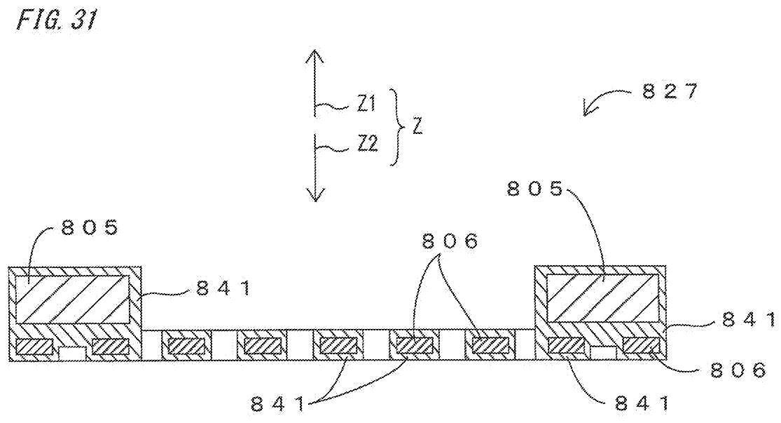

Next, a dehumidifying film 1, a dehumidifying element 2, a dehumidifying film production method, and a dehumidifying element production method according to embodiment 7 of the present invention will be described below with reference to the drawings. Embodiment 7 is similar to embodiment 1 described above. Difference of embodiment 7 from embodiment 1 will be mainly described below. FIG. 29 is a cross-sectional view of an anode 727 according to embodiment 7 of the present invention, as taken along a cross-sectional plane parallel to the axial direction Z. FIG. 30 is a flow chart showing the dehumidifying element production method according to embodiment 7 of the present invention.

In embodiment 7, the anode 727 includes an anode-side power feeder 705, a porous portion 706, and a plating film 741. The anode-side power feeder 705 includes an anode-side plate-like ring 710 formed in a circular ring shape, and an anode-side plate-like portion 711 formed in an elongated shape so as to extend from a part of the outer edge portion of the anode-side plate-like ring 710 in the axially inward direction Z1. The anode-side plate-like ring 710 and the anode-side plate-like portion 711 are formed as one member. An anode-side through hole 712 is formed near the end portion, in the axially inward direction Z1, of the anode-side plate-like portion 711 so as to penetrate in the radial direction. The anode-side plate-like ring 710 and the porous portion 706 are joined to each other by the plating film 741 and integrated. The thickness of the plating film 741 is set to be several tens of pm, whereby both the anode-side plate-like ring 710 and the porous portion 706 can be integrated. The plating film 741 is made of nickel (symbol of element: Ni). Therefore, even when the thickness is greater than that of the precious metal-plating, the process can be performed at low cost. The plating is electroless plating. If electroplating using direct current is performed, since current density between the anode-side power feeder 705 and the porous portion 706 becomes lower as compared to that in the surrounding region, a film cannot be efficiently formed. When electroless plating is performed, the plating film 741 having a sufficient thickness can be formed between the anode-side power feeder 705 and the porous portion 706, and both the anode-side power feeder 705 and the porous portion 706 can be integrated.

As shown in FIG. 30, in the method for producing the dehumidifying film 1 and the dehumidifying element according to embodiment 7, after the start of this process, the process shifts to the integrating step of the step a20, and plating process is performed. Next, the process shifts to the precious metal-plating step of step a2, and the surfaces of the anode-side power feeder 705, the plating film 741, and the porous portion 706 which have been integrated in the integrating step are further plated so as to be platinum-plated. The process steps from step a3 to step a5, the process steps from step c6 to step c9, and the process step of step a6 are the same as described for embodiment 1. However, the process for the conductive brazing material 14 in embodiment 1 is performed for the plating film 741 in embodiment 7. Thereafter, this process is ended. In the plurality of steps shown in FIG. 30, the steps indicated using an alternate long and two short dashes line b5 correspond to the dehumidifying film production method.

In embodiment 7, nickel-plating is performed for joining in the integrating step, and platinum-plating is performed in the precious metal-plating step. However, in the present invention, the metal films formed in the integrating step and the precious metal-plating step are not limited to a nickel film and a platinum film. In another embodiment of the present invention, another metal film having excellent joining properties may be formed in the integrating step, or another metal film having excellent corrosion resistance may be formed in the precious metal-plating step.

### Embodiment 8

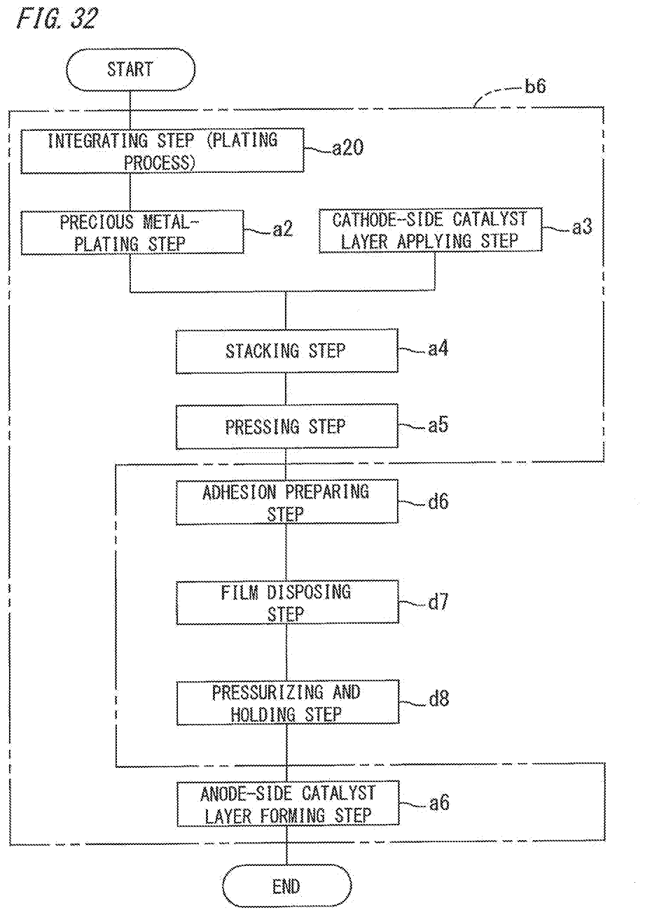

Next, a dehumidifying film 1, a dehumidifying element 2, a dehumidifying film production method, and a dehumidifying element production method according to embodiment 8 of the present invention will be described below with reference to the drawings. Embodiment 8 is similar to embodiment 2 described above. Difference of embodiment 8 from embodiment 2 will be mainly described below. FIG. 31 is a cross-sectional view of an anode 827 according to embodiment 8 of the present invention, as taken along a cross-sectional plane parallel to the axial direction Z. FIG. 32 is a flow chart showing the dehumidifying element production method according to embodiment 8 of the present invention.

In embodiment 8, an anode-side power feeder 805 and a porous portion 806 are joined to each other by a plating film 841 and integrated. Similarly to embodiment 7 described above, the thickness of the plating film 841 is set to several tens of μm, whereby both the anode-side power feeder 805 and the porous portion 806 can be integrated. The plating film 841 is made of nickel. Therefore, even when the thickness is greater than that of the precious metal-plating, the process can be performed at low cost. Furthermore, the plating is electroless plating. If electroplating using direct current is performed, since current density between the anode-side power feeder 805 and the porous portion 806 becomes lower as compared to that in the surrounding region, a film cannot be efficiently formed. When electroless plating is performed, the plating film 841 having a sufficient thickness can be formed between the anode-side power feeder 805 and the porous portion 806, and both the anode-side power feeder 805 and the porous portion 806 can be integrated.

As shown in FIG. 32, in the dehumidifying film production method and the dehumidifying element production method according to embodiment 8, after the start of this process, the process shifts to the integrating step of step a20, and plating process is performed. Next, the process shifts to the precious metal-plating step of step a2, and the surfaces of the anode-side power feeder 805, the plating film 841, and the porous portion 806 which have been integrated in the integrating step are further plated so as to be platinum-plated. The process steps from step a3 to step a5, the process steps from step d6 to step d8, and the process step of step a6 are the same as described for embodiment 2. However, the process for the conductive brazing material 214 in embodiment 2 is performed for the plating film 841 in embodiment 8. Thereafter, this process is ended. In the plurality of steps shown in FIG. 30, the steps indicated using an alternate long and two short dashes line b6 corresponds to the dehumidifying film production method.

In embodiment 8, nickel-plating is performed for joining in the integrating step, and platinum-plating is performed in the precious metal-plating step. However, in the present invention, the metal films formed in the integrating step and the precious metal-plating step are not limited to a nickel film and a platinum film. In another embodiment of the present invention, another metal film having excellent joining properties may be formed in the integrating step, or another metal film having excellent corrosion resistance may be formed in the precious metal-plating step.

In the present invention, the above-described embodiments may be freely combined with each other, or each of the above-described embodiments may be modified or omitted as appropriate, within the scope of the present invention.

### DESCRIPTION OF THE REFERENCE CHARACTERS

1 dehumidifying film

2 dehumidifying element

3 cathode-side electrode

4 cathode-side catalyst layer

5 anode-side power feeder

6 porous portion

7 electrolyte membrane

8 anode-side catalyst layer

9 cathode-side power feeder

10 anode-side plate-like ring

11 anode-side plate-like portion

12 anode-side through hole

13 intra-hole space

14 conductive brazing material

15 cathode-side plate-like ring

16 cathode-side plate-like portion

17 cathode-side through hole

18 housing

21 fitting member

22 flange member

23 tubular portion

24 flange

25 packing

27 anode

60 through hole

228 outer layer film

231 anode-side ring-like portion

232 anode-side drawn portion

233 center space region

234 cathode-side drawn portion

235 cathode-side ring-like portion

236 stacked body

337 power feeder material

338 inscribed circle

741 plating film

C1 connection area

C2 joining area

Z1 axially inward direction

Z2 axially outward direction

Z axial direction

X first direction

Y second direction

1. A dehumidifying film comprising:
a cathode-side electrode formed by a porous conductive member;
a cathode-side catalyst layer that is adjacent to and electrically connected to the cathode-side electrode;
an anode-side power feeder;
an anode-side catalyst layer for promoting reaction of electrolyzing water;
a porous portion having a plurality of through holes formed therein, the porous portion having one part that contacts with the anode-side catalyst layer and the other part that is electrically connected to and integrated with the anode-side power feeder; and
an electrolyte membrane that is adjacent to and electrically connected to the cathode-side catalyst layer and the porous portion, wherein
the anode-side power feeder, and the other part, of the porous portion, connected to the anode-side power feeder are joined to each other by a conductive brazing material that includes a same kind of metal as a metal of the anode-side power feeder and the porous portion, and the through holes formed in the other part are filled with the conductive brazing material.

2. The dehumidifying film according to claim 1, wherein the conductive brazing material, the anode-side power feeder, and the porous portion are formed from a same kind of metal.

3. The dehumidifying film according to claim 1, wherein a metal contained in the conductive brazing material, and the metal of the anode-side power feeder and the porous portion are titanium.

4. A dehumidifying element comprising:
the dehumidifying film according to claim 1; and
a housing, formed in a tubular shape, for housing the dehumidifying film.

5. A dehumidifying element comprising:
the dehumidifying film according to claim 1; and
an outer layer film for covering outer edge portions of the cathode-side electrode, the cathode-side catalyst layer, the porous portion, and the electrolyte membrane.

6. A dehumidifying film production method comprising:
an integrating step of forming an anode-side power feeder, and a porous portion having a plurality of through holes formed therein such that the anode-side power feeder and the porous portion are integrated with each other;
a cathode-side catalyst layer applying step of applying a precursor of a cathode-side catalyst layer such that the precursor thereof is adjacent to one side of a cathode-side electrode;
a stacking step of stacking an electrolyte membrane adjacent to the porous portion having been processed in the integrating step, and stacking the precursor, of the cathode-side catalyst layer, applied in the cathode-side catalyst layer applying step such that the precursor is adjacent to the electrolyte membrane;
a pressing step of pressurizing and pressing the porous portion, the electrolyte membrane, the precursor of the cathode-side catalyst layer, and the cathode-side electrode which have been stacked in the stacking step, to form the precursor of the cathode-side catalyst layer into the cathode-side catalyst layer; and
an anode-side catalyst layer forming step of forming an anode-side catalyst layer such that the anode-side catalyst layer is adjacent to a part of the porous portion having been processed in the pressing step, wherein
in the integrating step, the anode-side power feeder, and a connection area, of the porous portion, which is connected to the anode-side power feeder are joined to each other by a conductive brazing material that includes a same kind of metal as a metal of the anode-side power feeder and the porous portion, and the through holes formed in the connection area are filled with the conductive brazing material.

7. The dehumidifying film production method according to claim 6, wherein the conductive brazing material, the anode-side power feeder, and the porous portion are formed from a same kind of metal.

8. The dehumidifying film production method according to claim 6, wherein a metal contained in the conductive brazing material, and the metal of the anode-side power feeder and the porous portion are titanium.

9. A dehumidifying element production method comprising:
the dehumidifying film production method according to claim 6;
a housing step of disposing a cathode-side power feeder such that the cathode-side power feeder is adjacent to the cathode-side electrode, and housing the porous portion, the electrolyte membrane, the cathode-side catalyst layer, and the cathode-side electrode in a housing formed in a tubular shape;
an inserting step of inserting, in the housing having been processed in the housing step, at least a part of a tubular portion of a flange member having a flange formed at an end portion of the tubular portion which is formed in a tubular shape; and
a housing joining step of joining the housing and the flange member having been processed in the inserting step.

10. The dehumidifying element production method according to claim 9, wherein the housing and the flange member are joined by ultrasonic joining in the housing joining step.

11. A dehumidifying element production method comprising:
the dehumidifying film production method according to claim 6;
a film disposing step of covering outer edge portions of the cathode-side electrode, the cathode-side catalyst layer, the porous portion, and the electrolyte membrane, with a precursor of an outer layer film; and
a pressuring and holding step of pressurizing and holding the cathode-side electrode, the cathode-side catalyst layer, the porous portion, the electrolyte membrane, and the precursor of the outer layer film which have been processed in the film disposing step.

12. The dehumidifying film according to claim 2, wherein a metal contained in the conductive brazing material, and the metal of the anode-side power feeder and the porous portion are titanium.

13. A dehumidifying element comprising:
the dehumidifying film according to claim 2; and
a housing, formed in a tubular shape, for housing the dehumidifying film.

14. A dehumidifying element comprising:
the dehumidifying film according to claim 3; and
a housing, formed in a tubular shape, for housing the dehumidifying film.

15. A dehumidifying element comprising:
the dehumidifying film according to claim 2; and
an outer layer film for covering outer edge portions of the cathode-side electrode, the cathode-side catalyst layer, the porous portion, and the electrolyte membrane.

16. A dehumidifying element comprising:
the dehumidifying film according to claim 3; and
an outer layer film for covering outer edge portions of the cathode-side electrode, the cathode-side catalyst layer, the porous portion, and the electrolyte membrane.

17. The dehumidifying film production method according to claim 7, wherein a metal contained in the conductive brazing material, and the metal of the anode-side power feeder and the porous portion are titanium.

18. A dehumidifying element production method comprising:
the dehumidifying film production method according to claim 7;
a housing step of disposing a cathode-side power feeder such that the cathode-side power feeder is adjacent to the cathode-side electrode, and housing the porous portion, the electrolyte membrane, the cathode-side catalyst layer, and the cathode-side electrode in a housing formed in a tubular shape;
an inserting step of inserting, in the housing having been processed in the housing step, at least a part of a tubular portion of a flange member having a flange formed at an end portion of the tubular portion which is formed in a tubular shape; and
a housing joining step of joining the housing and the flange member having been processed in the inserting step.

19. A dehumidifying element production method comprising:
the dehumidifying film production method according to claim 8;
a housing step of disposing a cathode-side power feeder such that the cathode-side power feeder is adjacent to the cathode-side electrode, and housing the porous portion, the electrolyte membrane, the cathode-side catalyst layer, and the cathode-side electrode in a housing formed in a tubular shape;
an inserting step of inserting, in the housing having been processed in the housing step, at least a part of a tubular portion of a flange member having a flange formed at an end portion of the tubular portion which is formed in a tubular shape; and
a housing joining step of joining the housing and the flange member having been processed in the inserting step.

20. A dehumidifying element production method comprising:
the dehumidifying film production method according to claim 7;
a film disposing step of covering outer edge portions of the cathode-side electrode, the cathode-side catalyst layer, the porous portion, and the electrolyte membrane, with a precursor of an outer layer film; and
a pressuring and holding step of pressurizing and holding the cathode-side electrode, the cathode-side catalyst layer, the porous portion, the electrolyte membrane, and the precursor of the outer layer film which have been processed in the film disposing step.
